(19) United States
(12) Patent Application Publication
(10) Pub. No.: US 2024/0417510 A1
(43) Pub. Date: Dec. 19, 2024

(54) POLYSTYRENE COMBINED WITH IONOMERS HAVING AROMATIC BACKBONES

(71) Applicant: Twelve Benefit Corporation, Berkeley, CA (US)

(72) Inventors: Ziyang Huo, Moraga, CA (US); Chengtian Shen, Irvine, CA (US)

(73) Assignee: Twelve Benefit Corporation, Berkeley, CA (US)

(21) Appl. No.: 18/735,025

(22) Filed: Jun. 5, 2024

Related U.S. Application Data
(60) Provisional application No. 63/507,037, filed on Jun. 8, 2023.

(51) Int. Cl. C08G 61/10; H01M 10/0565; H01M 50/414

(52) U.S. Cl. CPC C08G 61/10; H01M 10/0565; H01M 50/414

(57) ABSTRACT

The present disclosure relates to polymers synthesized from ionomers having an aromatic hydrocarbon-containing backbone and an amine-containing ionic or ionizable moiety with polystyrene. The linkage between the ionomer and the polystyrene is made through covalent bonds or linking moieties. Electrochemical cells having polymer electrolyte membranes composed of the combined polymers are also described.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Greenhouse gas emissions such as CO₂ can have a potential impact on the climatic environment if left uncontrolled. The conversion of fossil fuels such as coal or natural gas into energy is a major source of greenhouse gas emissions. There is an urgent need for a system for more effective management of these carbon dioxide emissions. Improvements in carbon capture technology whereby a stream of low-quality and/or low-concentration gas is converted to a stream of higher quality and/or higher concentration of gas are of great interest to manufacturing and energy industries where the gases are generated.

Electrochemical conversion of CO₂ into formic acid, carbon monoxide and other chemicals is a promising technique for conversion of an undesirable gas and mitigation of climate change. A challenge to utilizing such a process is the ability to scale up to an industrial process which is both cost-effective and energy efficient. One aspect of increasing the efficiency of the electrochemical systems is optimization of the polymeric electrolyte membranes for electrochemical cells.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The present disclosure relates to combined polymers of an ionomer having an aromatic hydrocarbon-containing backbone and an amine-containing ionic or ionizable moiety and a polystyrene. Linkages are made through covalent bonds or linking moieties, joining the individual polymer backbones together, or joining the individual polymers through their side chains or pendant groups. In some embodiments, the polystyrene also includes an ionic or ionizable moiety. Electrochemical cells having polymer electrolyte membranes composed of the combined polymers are also described.

In a first aspect, the present disclosure encompasses a polymer. In some embodiments, the polymer has a structure of formula (I): P1-L-P2 (I), or a salt thereof, wherein P1 is an ionomer having an aromatic hydrocarbon-containing backbone; P2 is a polystyrene having a hydrocarbon backbone and pendant optionally substituted phenyl rings; and an amine-containing ionizable moiety or an amine-containing ionic moiety; and L is a linking moiety or a covalent bond.

In some embodiments, the ionomer includes structures of formula:

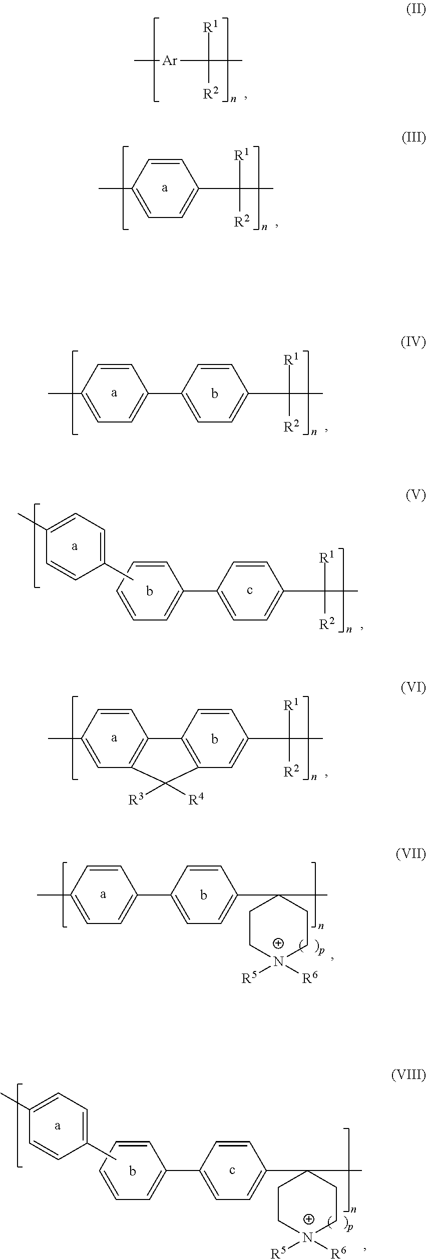

or a salt thereof, wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety; R³ and R⁴ each independently comprise H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R³ and R⁴ can be taken together to form an optionally substituted cyclic group; R⁵ and R⁶ each independently comprise H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁵ and R⁶ can be taken together to form an optionally substituted cyclic group; Ar includes or is an optionally substituted aromatic or optionally substituted arylene; n is an integer of 1 or more; p is 0, 1, 2, or more; and each of ring a, ring b, and ring c may independently be optionally substituted with one or more substituents comprising alkyl, alkoxy, amino, aminoalkyl, aryl, arylalkenyl, aryoyl, aryloxy, arylalkoxy, cyano, hydroxy, hydroxyalkyl, nitro, halo or haloalkyl; and wherein at least one of rings a-c, R¹, R², R³, and R⁴ of formulas (II)—(VI) is or includes an amine-containing ionizable moiety or an amine-containing ionic moiety.

In some embodiments, at least one of R¹ and R² is a side chain including the amine-containing ionizable moiety or the amine-containing ionic moiety.

In some embodiments, the amine-containing ionic moiety includes optionally substituted pyrazolium, optionally substituted pyridinium, optionally substituted pyrazinium, optionally substituted pyrimidinium, optionally substituted pyridazinium, optionally substituted piperidinium, optionally substituted pyrrolidinium, optionally substituted indolizinium, optionally substituted isoindolium, optionally substituted indazolium, optionally substituted imidazolium, optionally substituted oxazolium, optionally substituted triazolium, optionally substituted tetrazolium, optionally substituted thiazolium, optionally substituted purinium, optionally substituted isoquinolinium, optionally substituted quinolinium, optionally substituted phthalazinium, optionally substituted quinooxalinium, optionally substituted phenazinium, optionally substituted morpholinium, immonium, ammonium, guanidinium or histidinium.

In some embodiments, the ionomer comprises a structure of formula (V):

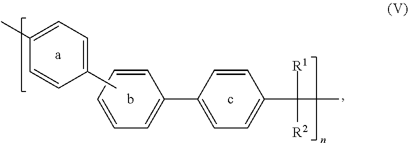

and R¹ comprises haloalkyl.

In some embodiments, the polystyrene has a structure of formula (IX):

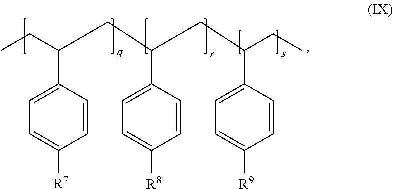

wherein R⁷, R⁸ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷, R⁸ and R⁹ is or includes an ionizable moiety or an ionic moiety; and each occurrence of q, r and s is independently an integer of 1 or more.

In some embodiments, wherein R¹ is trifluoromethyl and R² is a structure of formula (X):

—(C(R¹⁰)₂)ₜR¹¹ (X),

wherein each R¹⁰ independently is H, aliphatic, aralkyl, aryl, heteroaryl, alkoxy, aryloxy, thioalkyl, thioaralkyl, thioaryl, aminoalkyl, amino, aminoaryl, halo or hydroxyl; R¹¹ is amino or nitrogen-containing heterocyclyl; and t is an integer of 1 to 30.

In some embodiments, R¹ is trifluoromethyl and R² is a structure of formula (XI):

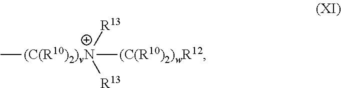

wherein each R¹⁰ independently is H, alkyl, aralkyl, aryl, heteroaryl, alkoxy, aryloxy, thioalkyl, thioaralkyl, thioaryl, aminoalkyl, amino, aminoaryl, halo or hydroxyl; R¹² is amino, aryl, heterocyclyl, hydroxyl, dihydroxyl, sulfhydryl, sulfide, disulfide, sulfo, or thioester; each R¹³ independently is H or aliphatic; v is an integer of 1 to 30; and w is an integer of 1 to 10.

In some embodiments, L is a linking moiety and wherein the linking moiety is a bifunctional moiety having two reactive ends linked by a spacer.

In some embodiments, the spacer is optionally substituted alkyl, optionally substituted aryl or optionally substituted heterocyclyl.

In some embodiments, each of the two reactive ends has the same functional group.

In some embodiments, the same functional group is an ether, an ester, a carbamate ester, an amide, an amine, a ketone, an epoxide, a heterocycle or a thioether.

In some embodiments, the linking moiety connects the side chain of the ionomer including the amine-containing ionizable moiety or the amine-containing ionic moiety to a pendant optionally substituted phenyl ring of the polystyrene.

In some embodiments, the linking moiety connects the aromatic hydrocarbon-containing backbone of the ionomer to the hydrocarbon backbone of the polystyrene.

In some embodiments, the linking moiety is an optionally substituted alkyl, optionally substituted diester or optionally substituted aryl dicarbamate ester.

In some embodiments, L is a covalent bond and the covalent bond connects the aromatic hydrocarbon-containing backbone of the ionomer to a pendant optionally substituted phenyl ring of the polystyrene.

In some embodiments, the linking moiety is an optionally substituted alkyl diammonium or optionally substituted alkyl diimidazolium.

In some embodiments, the polystyrene is a terpolymer, and the terpolymer has a pendant alkyl imidazolium-substituted phenyl ring.

In a second aspect, the present disclosure encompasses a branched polymer. In some embodiments, the branched polymer has a structure of formula (XII):

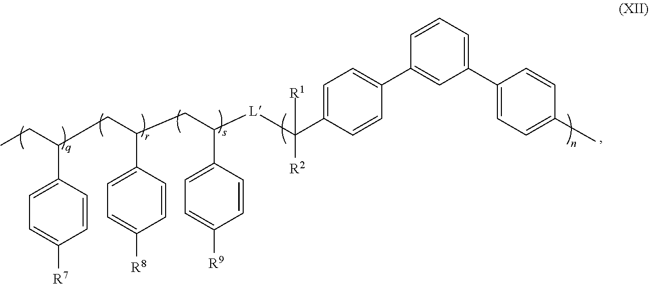

or a salt thereof, wherein R¹ and R² are each independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² is an electron-withdrawing moiety; R⁷, R⁸ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷, R⁸ and R⁹ is or includes an ionizable moiety or an ionic moiety; L′ is a linking moiety and wherein the linking moiety is a bifunctional moiety having two reactive ends linked by a spacer; n is an integer of 1 or more; and each occurrence of q, r and s is independently an integer of 1 or more.

In some embodiments, the spacer is optionally substituted alkyl, optionally substituted aryl or optionally substituted heterocyclyl.

In some embodiments, each of the two reactive ends is the same functional group.

In some embodiments, the same functional group is an ether, an ester, a carbamate ester, an amide, an amine, a ketone, an epoxide, a heterocycle or a thioether.

In a third aspect, the present disclosure encompasses a branched polymer. In some embodiments, the branched polymer has a structure of formula (XIII):

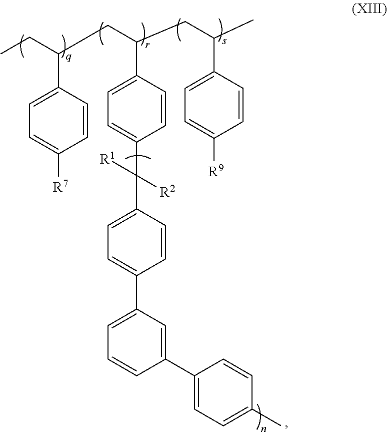

or a salt thereof, wherein R¹ and R² are each independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² is an electron-withdrawing moiety; R⁷ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷ and R⁹ is or includes an ionizable moiety or an ionic moiety; n is an integer of 1 or more; and each occurrence of q, r and s is independently an integer of 1 or more.

In a fourth aspect, the present disclosure encompasses a crosslinked polymer. In some embodiments, the crosslinked polymer has a structure of formula (XIV):

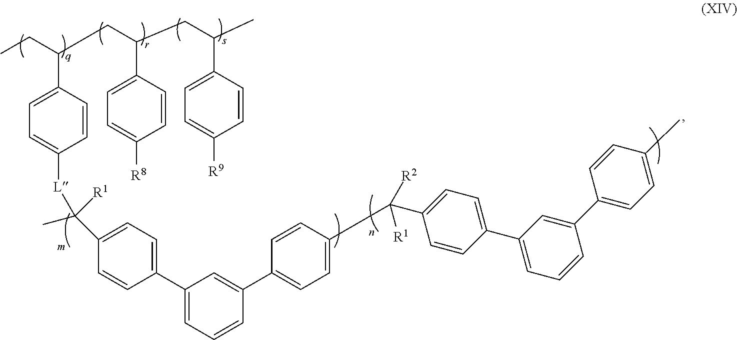

or a salt thereof, wherein R¹ and R² are each independently an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² is an electron-withdrawing moiety; R⁸ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁸ and R⁹ is or includes an ionizable moiety or an ionic moiety; L″ is a linking moiety and wherein the linking moiety is a bifunctional moiety having two reactive ends linked by a spacer; each occurrence of m and n is independently an integer of 1 or more; and each occurrence of q, r and s is independently an integer of 1 or more.

In some embodiments, the spacer is optionally substituted alkyl, optionally substituted aryl or optionally substituted heterocyclyl.

In some embodiments, each of the two reactive ends has the same functional group.

In some embodiments, the same functional group is an ether, an ester, a carbamate ester, an amide, an amine, a ketone, an epoxide, a heterocycle or a thioether.

In a fifth aspect, the present disclosure encompasses an electrochemical cell. In some embodiments, the electrochemical cell includes an anode; a cathode; and a polymer electrolyte membrane disposed between the anode and the cathode, wherein the polymer electrolyte membrane includes the polymers disclosed herein.

### Definitions

As used herein, the term “about” is understood to account for minor increases and/or decreases beyond a recited value, which changes do not significantly impact the desired function of the parameter beyond the recited value(s). In some cases, “about” encompasses +/−10% of any recited value. As used herein, this term modifies any recited value, range of values, or endpoints of one or more ranges.

The term “acyl,” or “alkanoyl,” as used interchangeably herein, represents an alkyl group, as defined herein, or hydrogen attached to the parent molecular group through a carbonyl group, as defined herein. This group is exemplified by formyl, acetyl, propionyl, butanoyl, and the like. The alkanoyl group can be substituted or unsubstituted. For example, the alkanoyl group can be substituted with one or more substitution groups, as described herein for alkyl. In some embodiments, the unsubstituted acyl group is a C₂₋₇ acyl or alkanoyl group. In particular embodiments, the alkanoyl group is —C(O)-Ak, in which Ak is an alkyl group, as defined herein.

By “aliphatic” is meant a hydrocarbon moiety having at least one carbon atom to 50 carbon atoms (C₁₋₅₀), such as one to 25 carbon atoms (C₁₋₂₅), or one to ten carbon atoms (C₁₋₁₀), and which includes saturated groups such as alkanes (or alkyl) and unsaturated groups such as alkenes (or alkenyl), alkynes (or alkynyl), and also includes cyclic versions thereof, and further including straight- and branched-chain arrangements, and all stereo and position isomers as well. Such a hydrocarbon can be unsubstituted or substituted with one or more groups, such as halogens or groups described herein for an alkyl group.

By “alkenyl” is meant an optionally substituted C₂₋₂₄ alkyl group having one or more double bonds. The alkenyl group can be cyclic (e.g., C₃₋₂₄ cycloalkenyl) or acyclic. The alkenyl group can also be substituted or unsubstituted. For example, the alkenyl group can be substituted with one or more substitution groups, as described herein for alkyl. Non-limiting unsubstituted alkenyl groups include C₂₋₈ alkenyl, C₂₋₆ alkenyl, C₂₋₅ alkenyl, C₂₋₄ alkenyl, or C₂₋₃ alkenyl. Exemplary, non-limiting alkenyl groups include vinyl or ethenyl (—CH═CH₂), 1-propenyl (—CH═CHCH₃), allyl or 2-propenyl (—CH₂—CH═CH₂), 1-butenyl (—CH═CHCH₂CH₃), 2-butenyl (—CH₂CH═CHCH₃), 3-butenyl (e.g. —CH₂CH₂CH═CH₂), 2-butenylidene (e.g., =CH—CH═CHCH₃), and the like.

By “alkenylene” is meant a multivalent (e.g., bivalent) form of an alkenyl group, which is an optionally substituted C₂₋₂₄ alkyl group having one or more double bonds. The alkenylene group can be cyclic (e.g., C₃₋₂₄ cycloalkenyl) or acyclic. The alkenylene group can be substituted or unsubstituted. For example, the alkenylene group can be substituted with one or more substitution groups, as described herein for alkyl. Exemplary, non-limiting alkenylene groups include —CH═CH— or —CH═CHCH₂—.

By “alkoxy” is meant —OR, where R is an optionally substituted alkyl group, as described herein. Exemplary alkoxy groups include methoxy, ethoxy, butoxy, trihaloalkoxy, such as trifluoromethoxy, etc. The alkoxy group can be substituted or unsubstituted. For example, the alkoxy group can be substituted with one or more substitution groups, as described herein for alkyl. Exemplary unsubstituted alkoxy groups include C₁₋₃, C₁₋₆, C₁₋₁₂, C₁₋₁₆, C₁₋₁₈, C₁₋₂₀, or C₁₋₂₄ alkoxy groups.

By “alkoxyalkyl” is meant an alkyl group, as defined herein, which is substituted with an alkoxy group, as defined herein. Exemplary unsubstituted alkoxyalkyl groups include between 2 to 12 carbons (C₂₋₁₂ alkoxyalkyl), as well as those having an alkyl group with 1 to 6 carbons and an alkoxy group with 1 to 6 carbons (i.e., C₁₋₆ alkoxy-C₁₋₆ alkyl).

By “alkyl” and the prefix “alk” is meant a branched or unbranched saturated hydrocarbon group of 1 to 24 carbon atoms, such as methyl (Me), ethyl (Et), n-propyl (n-Pr or nPr), isopropyl (i-Pr or iPr), cyclopropyl, n-butyl (n-Bu or nBu), isobutyl (i-Bu or iBu), s-butyl (s-Bu or sBu), t-butyl (t-Bu or tBu), cyclobutyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can include haloalkyl, in which the alkyl group is substituted by one or more halo groups, as described herein. In another example, the alkyl group can be substituted with one, two, three or, in the case of alkyl groups of two carbons or more, four substituents independently selected from the group consisting of: (1) C₁₋₆ alkoxy (e.g., —O-Ak, wherein Ak is optionally substituted C₁₋₆ alkyl); (2) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (3) aryl; (4) arylalkoxy (e.g., —O-Lk-Ar, wherein Lk is a bivalent form of optionally substituted alkyl and Ar is optionally substituted aryl); (5) aryloyl (e.g., —C(O)—Ar, wherein Ar is optionally substituted aryl); (6) cyano (e.g., —CN); (7) carboxyaldehyde (e.g., —C(O)H); (8) carboxyl (e.g., —CO₂H); (9) C₃₋₈ cycloalkyl (e.g., a monovalent saturated or unsaturated non-aromatic cyclic C₃₋₈ hydrocarbon group); (10) halo (e.g., F, Cl, Br, or I); (11) heterocyclyl (e.g., a 3-, 4-, 5-, 6- or 7-membered ring, unless otherwise specified, containing one, two, three, or four non-carbon heteroatoms, such as nitrogen, oxygen, phosphorous, sulfur, or halo); (12) heterocyclyloxy (e.g., —O-Het, wherein Het is heterocyclyl, as described herein); (13) heterocyclyloyl (e.g., —C(O)—Het, wherein Het is heterocyclyl, as described herein); (14) hydroxyl (e.g., —OH); (15) N-protected amino; (16) nitro (e.g., —NO₂); (17) oxo (e.g., ═O); (18) —CO₂R^{A}, where R^{A} is selected from the group consisting of (a) C₁₋₆ alkyl, (b) C₄₋₁₈ aryl, and (c) (C₄₋₁₈ aryl) C₁₋₆ alkyl (e.g., -Lk-Ar, wherein Lk is a bivalent form of optionally substituted alkyl group and Ar is optionally substituted aryl); (19) —C(O)NR^{B}R^{C}, where each of R^{B} and R^{C} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -Lk-Ar, wherein Lk is a bivalent form of optionally substituted alkyl group and Ar is optionally substituted aryl); and (20) —NR^{G}R^{H}, where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., Lk-Ar, wherein Lk is a bivalent form of optionally substituted alkyl group and Ar is optionally substituted aryl), (h) C₃₋₈ cycloalkyl, and (i) (C₃₋₈ cycloalkyl) C₁₋₆ alkyl (e.g., -Lk-Cy, wherein Lk is a bivalent form of optionally substituted alkyl group and Cy is optionally substituted cycloalkyl, as described herein), wherein in one embodiment no two groups are bound to the nitrogen atom through a carbonyl group. The alkyl group can be a primary, secondary, or tertiary alkyl group substituted with one or more substituents (e.g., one or more halo or alkoxy). In some embodiments, the unsubstituted alkyl group is a C₁₋₂, C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkyl group.

By “alkylene” is meant a multivalent (e.g., bivalent) form of an alkyl group, as described herein. Exemplary alkylene groups include methylene, ethylene, propylene, butylene, etc. In some embodiments, the alkylene group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can also be substituted or unsubstituted. For example, the alkylene group can be substituted with one or more substitution groups, as described herein for alkyl.

By “alkyleneoxy” is meant an alkylene group, as defined herein, attached to the parent molecular group through an oxygen atom.

By “alkylcarbonyl” is meant an alkyl group as previously defined appended to the parent molecular moiety through a carbonyl group. Exemplary, non-limiting alkylcarbonyl groups include methylcarbonyl, ethylcarbonyl, and isopropylcarbonyl among others.

By “alkynyl” is meant an optionally substituted C₂₋₂₄ alkyl group having one or more triple bonds. The alkynyl group can be cyclic or acyclic and is exemplified by ethynyl, 1-propynyl, and the like. The alkynyl group can also be substituted or unsubstituted. For example, the alkynyl group can be substituted with one or more substitution groups, as described herein for alkyl. Non-limiting unsubstituted alkynyl groups include C₂₋₈ alkynyl, C₂₋₆ alkynyl, C₂₋₅ alkynyl, C₂₋₄ alkynyl, or C₂₋₃ alkynyl. Exemplary, non-limiting alkynyl groups include ethynyl (—C≡CH), 1-propynyl (—C≡CCH₃), 2-propynyl or propargyl (—CH₂C≡CH), 1-butynyl (—C≡CCH₂CH₃), 2-butynyl (—CH₂C≡CCH₃), 3-butynyl (—CH₂CH₂C≡CH), and the like.

By “alkynylene” is meant a multivalent (e.g., bivalent) form of an alkynyl group, which is an optionally substituted C₂₋₂₄ alkyl group having one or more triple bonds. The alkynylene group can be cyclic or acyclic. The alkynylene group can be substituted or unsubstituted. For example, the alkynylene group can be substituted with one or more substitution groups, as described herein for alkyl. Exemplary, non-limiting alkynylene groups include —C≡C— or —C≡CCH₂—.

By “amido” is meant —N(R^{N1})C(O)—, where R^{N1} is H, optionally substituted alkyl, or optionally substituted aryl.

By “amino” is meant —NR^{N1}R^{N2}, where each of R^{N1} and R^{N2} is, independently, H, optionally substituted alkyl, or optionally substituted acyl, or optionally substituted aryl, or R^{N1} and R^{N2}, taken together with the nitrogen atom to which each are attached, form a heterocyclyl group, as defined herein.

By “aminoalkyl” is meant an alkyl group, as defined herein, substituted by an amino group, as defined herein.

By “aminoaryl” is meant an aryl group, as defined herein, substituted by an amino group, as defined herein.

By “ammonium” is meant a group including a protonated nitrogen atom N⁺. Exemplary ammonium groups include —N⁺R^{N1}R^{N2}R^{N3} where each of R^{N1}, R^{N2}, and R^{N3} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group or heterocycle; or R^{N1} and R^{N2}, taken together, form an optionally substituted alkylene or heteroalkylene (e.g., as described herein); or R^{N1} and R^{N2} and R^{N3}, taken together with the nitrogen atom to which each are attached, form an optionally substituted heterocyclyl group or heterocycle, such as a heterocyclic cation.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Huckel rule (4n+2). The point of attachment to the parent structure typically is through an aromatic portion of the condensed ring system. Such an aromatic can be unsubstituted or substituted with one or more groups, such as groups described herein for an alkyl or aryl group. Yet other substitution groups can include aliphatic, haloaliphatic, halo, nitrate, cyano, sulfonate, sulfonyl, or others.

By “aryl” is meant a group that contains any carbon-based aromatic group including, but not limited to, phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted or unsubstituted. The aryl group can be substituted with one, two, three, four, or five substituents, such as any described herein for alkyl.

By “arylalkoxy” is meant an arylalkylene group, as defined herein, attached to the parent molecular group through an oxygen atom. In some embodiments, the arylalkoxy group is —O-Ak-Ar, in which Ak is an optionally substituted alkylene, as defined herein, and Ar is an optionally substituted aryl, as defined herein.

By “(aryl)(alkyl)ene” is meant a bivalent form including an arylene group, as described herein, attached to an alkylene or a heteroalkylene group, as described herein. In some embodiments, the (aryl)(alkyl)ene group is -L-Ar— or -L-Ar-L- or —Ar-L-, in which Ar is an arylene group and each L is, independently, an optionally substituted alkylene group or an optionally substituted heteroalkylene group.

By “arylalkylene” is meant an aryl group, as defined herein, attached to the parent molecular group through an alkylene group, as defined herein. In some embodiments, the arylalkylene group is -Ak-Ar, in which Ak is an optionally substituted alkylene, as defined herein, and Ar is an optionally substituted aryl, as defined herein. The arylalkylene group can be substituted or unsubstituted. For example, the arylalkylene group can be substituted with one or more substitution groups, as described herein for aryl and/or alkyl. Exemplary unsubstituted arylalkylene groups are of from 7 to 16 carbons (C₇₋₁₆ arylalkylene), as well as those having an aryl group with 4 to 18 carbons and an alkylene group with 1 to 6 carbons (i.e., (C₄₋₁₈ aryl)C₁₋₆ alkylene).

By “arylene” is meant a multivalent (e.g., bivalent, trivalent, tetravalent, etc.) form of an aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for aryl.

By “aryleneoxy” is meant an arylene group, as defined herein, attached to the parent molecular group through an oxygen atom.

By “aryloxy” is meant an aryl group, as defined herein, attached to the parent molecular group through an oxygen atom.

By “aryloyl” is meant an aryl group that is attached to the parent molecular group through a carbonyl group. In some embodiments, an unsubstituted aryloyl group is a C₇₋₁₁ aryloyl or C₅₋₁₉ aryloyl group. In particular embodiments, the aryloyl group is —C(O)—Ar, in which Ar is an aryl group, as defined herein.

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

By “azido” is meant —N₃.

By “boranyl” is meant a —BR₂ group, in which each R, independently, can be H, halo, or optionally substituted alkyl.

By “borono” is meant a —BOH₂ group.

By “branched alkenyl” is meant an isomer of a straight chain alkenyl compound; one having alkyl groups bonded to the main carbon chain.

By “carbonyl” is meant a —C(O)— group, which can also be represented as >C═O.

By “carboxyl” is meant a —CO₂H group.

By “carboxylate anion” is meant a —CO₂ group.

By “covalent bond” is meant a covalent bonding interaction between two components. Non-limiting covalent bonds include a single bond, a double bond, a triple bond, or a spirocyclic bond, in which at least two molecular groups are bonded to the same carbon atom.

By “cyano” is meant —CN.

By “cyclic group” is used herein to refer to either aryl groups, non-aryl groups (e.g., cycloalkyl or heterocycloalkyl groups), or both. Cyclic groups have one or more ring systems that can be substituted or unsubstituted. A cyclic group can contain one or more aryl groups, one or more non-aryl groups, or one or more aryl groups and one or more non-aryl groups.

By “cycloalkyl” is meant a monovalent saturated or unsaturated non-aromatic or aromatic cyclic hydrocarbon group of from three to eight carbons, unless otherwise specified, and is exemplified by cyclopropyl, cyclobutyl, cyclopentyl, cyclopentadienyl, cyclohexyl, cycloheptyl, bicyclo[2.2.1.]heptyl, and the like. The cycloalkyl group can also be substituted or unsubstituted. For example, the cycloalkyl group can be substituted with one or more groups including those described herein for alkyl.

By “dicarbonyl” is meant any moiety or compound including two carbonyl groups, as defined herein. Non-limiting dicarbonyl moieties include 1,2-dicarbonyl (e.g., R^{C1}—C(O)—C(O)R^{C2}, in which each of R^{C1} and R^{C2} is, independently, optionally substituted alkyl, halo, optionally substituted alkoxy, hydroxyl, or a leaving group); 1,3-dicarbonyl (e.g., R^{C1}—C(O)—C(R^{1a}R^{2a})—C(O)R^{C2}, in which each of R^{C1} and R^{C2} is, independently, optionally substituted alkyl, halo, optionally substituted alkoxy, hydroxyl, or a leaving group and in which each of R^{1a} and R^{2a} is, independently, H or an optional substituent provided for alkyl, as defined herein); and 1,4-dicarbonyl (e.g., R^{C1}—C(O)—C(R^{1a}R^{2a})—C(R^{3a}R^{4a})—C(O)R^{C2}, in which each of R^{C1} and R^{C2} is, independently, optionally substituted alkyl, halo, optionally substituted alkoxy, hydroxyl, or a leaving group and in which each of R^{1a}, R^{2a}, R^{3a}, and R^{4a} is, independently, H or an optional substituent provided for alkyl, as defined herein).

By “electron withdrawing moiety” is meant a moiety capable of donating at least a portion of its electron density into the ring or functional group to which it is directly attached, such as by resonance.

By “halo” is meant F, Cl, Br, or I.

By “halo containing substituent” is meant a group that contains a halo, such as a haloaliphatic or haloalkyl group.

By “haloaliphatic” is meant an aliphatic group, as defined herein, substituted with one or more halo.

By “haloalkenyl” is meant an alkenyl group, as defined herein, substituted with one or more halo.

By “haloalkynyl” is meant an alkynyl group, as defined herein, substituted with one or more halo.

By “haloalkyl” is meant an alkyl group, as defined herein, substituted with one or more halogen. Non-limiting unsubstituted haloalkyl groups include C₁₋₂ haloalkyl, C₁₋₃ haloalkyl, C₁₋₄ haloalkyl, C₁₋₅ haloalkyl, C₁₋₆ haloalkyl, C₂₋₃ haloalkyl, C₂₋₄ haloalkyl, C₂₋₅ haloalkyl, C₂₋₆ haloalkyl, or C₃₋₆ haloalkyl. Other non-limiting haloalkyl groups include —CX_{y}H_{3-y}, wherein y is 1, 2, or 3, and wherein each X is, independently, halo (F, Cl, Br, or I); —CX_{z}H_{2-z}CX_{y}H_{3-y}, wherein z is 0, 1, or 2, wherein y is 0, 1, 2, or 3, and wherein each X is, independently, halo (F, Cl, Br, or I), in which at least one of z or y is not 0; —CH₂CX_{y}H_{3-y}, wherein y is 1, 2, or 3, and wherein each X is, independently, halo (F, Cl, Br, or I); —CX_{z1}H_{2-z1}CX_{z2}H_{2-z2}CX_{y}H_{3-y}, wherein each of z1 and z2 is, independently, 0, 1, or 2, wherein y is 0, 1, 2, or 3, and wherein each X is, independently, halo (F, Cl, Br, or I), in which at least one of z1, z2, or y is not 0; and —CX_{z}H_{1-z}[CX_{y1}H_{3-y1}][CX_{y2}H_{3-y2}], wherein z is 0 or 1, wherein each of y1 and y2 is, independently, 0, 1, 2, or 3, and wherein each X is, independently, halo (F, Cl, Br, or I), in which at least one of z, y1, or y2 is not 0.

By “haloalkylene” is meant an alkylene group, as defined herein, substituted with one or more halo.

By “heteroaliphatic” is meant an aliphatic group, as defined herein, including at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group.

By “heteroalkyl” is meant an alkyl group, as defined herein, containing one, two, three, or four non-carbon heteroatoms (e.g., independently selected from the group consisting of nitrogen, oxygen, phosphorous, sulfur, selenium, or halo).

By “heteroalkylene” is meant an alkylene group, as defined herein, containing one, two, three, or four non-carbon heteroatoms (e.g., independently selected from the group consisting of nitrogen, oxygen, phosphorous, sulfur, selenium, or halo). The heteroalkylene group can be saturated or unsaturated (e.g., having one or more double bonds or triple bonds). The heteroalkylene group can be substituted or unsubstituted. For example, the heteroalkylene group can be substituted with one or more substitution groups, as described herein for alkyl.

By “heteroaryl” is meant a subset of heterocyclyl groups, as defined herein, which are aromatic, i.e., they contain 4n+2 pi electrons within the mono- or multicyclic ring system.

The term “heterocycloalkyl” is a type of cycloalkyl group as defined above where at least one of the carbon atoms and its attached hydrogen atoms, if any, are replaced by O, S, N, or NH. The heterocycloalkyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein.

By “heterocycle” is meant a compound having one or more heterocyclyl moieties. Non-limiting heterocycles include optionally substituted imidazole, optionally substituted triazole, optionally substituted tetrazole, optionally substituted pyrazole, optionally substituted imidazoline, optionally substituted pyrazoline, optionally substituted imidazolidine, optionally substituted pyrazolidine, optionally substituted pyrrole, optionally substituted pyrroline, optionally substituted pyrrolidine, optionally substituted tetrahydrofuran, optionally substituted furan, optionally substituted thiophene, optionally substituted oxazole, optionally substituted isoxazole, optionally substituted isothiazole, optionally substituted thiazole, optionally substituted oxathiolane, optionally substituted oxadiazole, optionally substituted thiadiazole, optionally substituted sulfolane, optionally substituted succinimide, optionally substituted thiazolidinedione, optionally substituted oxazolidone, optionally substituted hydantoin, optionally substituted pyridine, optionally substituted piperidine, optionally substituted pyridazine, optionally substituted piperazine, optionally substituted pyrimidine, optionally substituted pyrazine, optionally substituted triazine, optionally substituted pyran, optionally substituted pyrylium, optionally substituted tetrahydropyran, optionally substituted dioxine, optionally substituted dioxane, optionally substituted dithiane, optionally substituted trithiane, optionally substituted thiopyran, optionally substituted thiane, optionally substituted oxazine, optionally substituted morpholine, optionally substituted thiazine, optionally substituted thiomorpholine, optionally substituted cytosine, optionally substituted thymine, optionally substituted uracil, optionally substituted thiomorpholine dioxide, optionally substituted indene, optionally substituted indoline, optionally substituted indole, optionally substituted isoindole, optionally substituted indolizine, optionally substituted indazole, optionally substituted benzimidazole, optionally substituted azaindole, optionally substituted azaindazole, optionally substituted pyrazolopyrimidine, optionally substituted purine, optionally substituted benzofuran, optionally substituted isobenzofuran, optionally substituted benzothiophene, optionally substituted benzisoxazole, optionally substituted anthranil, optionally substituted benzisothiazole, optionally substituted benzoxazole, optionally substituted benzthiazole, optionally substituted benzthiadiazole, optionally substituted adenine, optionally substituted guanine, optionally substituted tetrahydroquinoline, optionally substituted dihydroquinoline, optionally substituted dihydroisoquinoline, optionally substituted quinoline, optionally substituted isoquinoline, optionally substituted quinolizine, optionally substituted quinoxaline, optionally substituted phthalazine, optionally substituted quinazoline, optionally substituted cinnoline, optionally substituted naphthyridine, optionally substituted pyridopyrimidine, optionally substituted pyridopyrazine, optionally substituted pteridine, optionally substituted chromene, optionally substituted isochromene, optionally substituted chromenone, optionally substituted benzoxazine, optionally substituted quinolinone, optionally substituted isoquinolinone, optionally substituted carbazole, optionally substituted dibenzofuran, optionally substituted acridine, optionally substituted phenazine, optionally substituted phenoxazine, optionally substituted phenothiazine, optionally substituted phenoxathiine, optionally substituted quinuclidine, optionally substituted azaadamantane, optionally substituted dihydroazepine, optionally substituted azepine, optionally substituted diazepine, optionally substituted oxepane, optionally substituted thiepine, optionally substituted thiazepine, optionally substituted azocane, optionally substituted azocine, optionally substituted thiocane, optionally substituted azonane, optionally substituted azecine, etc. Optional substitutions include any described herein for aryl. Heterocycles can also include cations and/or salts of any of these (e.g., any described herein, such as optionally substituted piperidinium, optionally substituted pyrrolidinium, optionally substituted pyrazolium, optionally substituted imidazolium, optionally substituted pyridinium, optionally substituted quinolinium, optionally substituted isoquinolinium, optionally substituted acridinium, optionally substituted phenanthridinium, optionally substituted pyridazinium, optionally substituted pyrimidinium, optionally substituted pyrazinium, optionally substituted phenazinium, or optionally substituted morpholinium).

By “heterocyclyl” is meant a 3-, 4-, 5-, 6- or 7-membered ring, unless otherwise specified, containing one, two, three, or four non-carbon heteroatoms (e.g., independently selected from the group consisting of nitrogen, oxygen, phosphorous, sulfur, selenium, or halo). The 3-membered ring has zero to one double bonds, the 4- and 5-membered ring has zero to two double bonds, and the 6- and 7-membered rings have zero to three double bonds. The term “heterocyclyl” also includes bicyclic, tricyclic and tetracyclic groups in which any of the above heterocyclic rings is fused to one, two, or three rings independently selected from the group consisting of an aryl ring, a cyclohexane ring, a cyclohexene ring, a cyclopentane ring, a cyclopentene ring, and another monocyclic heterocyclic ring, such as indolyl, quinolyl, isoquinolyl, tetrahydroquinolyl, benzofuryl, benzothienyl and the like. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, aziridinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotriazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl, benzylsultimyl, bipyrazinyl, bipyridinyl, carbazolyl (e.g., 4H-carbazolyl), carbolinyl (e.g., β-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperidinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be substituted or unsubstituted. For example, the heterocyclyl group can be substituted with one or more substitution groups, as described herein for aryl.

By “heterocyclyldiyl” is meant a bivalent form of a heterocyclyl group, as described herein. In one instance, the heterocyclyldiyl is formed by removing a hydrogen from a heterocyclyl group. Exemplary heterocyclyldiyl groups include piperdylidene, quinolinediyl, etc. The heterocyclyldiyl group can also be substituted or unsubstituted. For example, the heterocyclyldiyl group can be substituted with one or more substitution groups, as described herein for heterocyclyl.

By “hydroxyalkyl” is meant an alkyl group, as defined herein, substituted with one or more hydroxyl.

By “hydroxyalkylene” is meant an alkylene group, as defined herein, substituted with one or more hydroxy.

By “hydroxyl” is meant —OH.

By “imino” is meant —NR—, in which R can be H or optionally substituted alkyl.

By “isocyanato” is meant —NCO.

By “isothiocyanato” is meant —N═C═S.

By “leaving group” is meant an atom (or a group of atoms) with electron withdrawing ability that can be displaced as a stable species, taking with it the bonding electrons, or an atom (or a group of atoms) that can be replaced by a substitution reaction. Examples of suitable leaving groups include H, halides, and sulfonates including, but not limited to, triflate (—OTf), mesylate (—OMs), tosylate (—OTs), brosylate (—OBs), acetate, Cl, Br, and I.

By “nitro” is meant an —NO₂ group.

By “oxo” is meant an ═O group.

By “oxy” is meant —O—.

By “phosphate” is meant a group derived from phosphoric acid. One example of phosphate includes a —O—P(═O)(OR^{P1})(OR^{P2}) or —O—[P(═O)(OR^{P1})—O]_{P3}—R^{P2} group, where each of R^{P1} and R^{P2}, is, independently, H, optionally substituted alkyl, optionally substituted alkenyl, optionally substituted aryl, or optionally substituted arylalkylene, and where P3 is an integer from 1 to 5. Yet other examples of phosphate include orthophosphoric acid, pyrophosphoric acid, tripolyphosphoric acid, tetrapolyphosphoric acid, trimetaphosphoric acid, and/or phosphoric anhydride, or combinations thereof.

By “phosphono” or “phosphonic acid” is meant a —P(O)(OH)₂ group.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S M et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt).

Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like.

Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine.

Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium). Yet other salts can include an anion, such as a halide (e.g., F⁻, Cl⁻, Br⁻, or I⁻), a hydroxide (e.g., OH⁻), a borate (e.g., tetrafluoroborate (BF₄⁻), a carbonate (e.g., CO₃²⁻ or HCO₃⁻), or a sulfate (e.g., SO₄²⁻).

By “silyl” is meant a —SiR¹R²R³ or —SiR¹R²— group. In some embodiments, each of R¹, R², and R³ is, independently, H, optionally substituted aliphatic, optionally substituted heteroaliphatic, optionally substituted aromatic, optionally substituted heteroaromatic, or optionally substituted amino. In particular embodiments, each of R¹, R², and R³ is, independently, H, optionally substituted alkyl, optionally substituted alkoxy, optionally substituted aryl, optionally substituted aryloxy, optionally substituted alkyl-aryl, optionally substituted aryl-alkyl, or optionally substituted amino. In other embodiments, the silyl group is —Si(R)ₐ(OR)_{b}(NR₂)_{c}, in which each R is, independently, H, optionally substituted aliphatic, optionally substituted heteroaliphatic, optionally substituted aromatic, or optionally substituted heteroaromatic; each of a, b, and c≥0; and a+b+c=3. In particular embodiments, each R is, independently, H, optionally substituted alkyl, optionally substituted aryl, optionally substituted alkyl-aryl, or optionally substituted aryl-alkyl.

By “spirocyclyl” is meant an alkylene diradical, both ends of which are bonded to the same carbon atom of the parent group to form a spirocyclyl group and also a heteroalkylene diradical, both ends of which are bonded to the same atom. Non-limiting alkylene and heteroalkylene groups for use within a spirocyclyl group includes C₂₋₁₂, C₂₋₁₁, C₂₋₁₀, C₂₋₉, C₂₋₈, C₂₋₇, C₂₋₆, C₂₋₅, C₂₋₄, or C₂₋₃ alkylene groups, as well as C₁₋₁₂, C₁₋₁₁, C₁₋₁₀, C₁₋₉, C₁₋₈, C₁₋₇, C₁₋₆, C₁₋₅, C₁₋₄, C₁₋₃, or C₁₋₂ heteroalkylene groups having one or more heteroatoms.

By “sulfate” is meant a group derived from sulfuric acid. One example of sulfate includes a —O—S(═O)₂(OR^{S1}) group, where R^{S1} is H, optionally substituted alkyl, optionally substituted alkenyl, optionally substituted aryl, or optionally substituted arylalkylene.

By “sulfo” or “sulfonic acid” is meant an —S(O)₂OH group.

By “sulfonyl” is meant an —S(O)₂— or —S(O)₂R group, in which R can be H, optionally substituted alkyl, or optionally substituted aryl. Non-limiting sulfonyl groups can include a trifluoromethylsulfonyl group (—SO₂—CF₃ or Tf).

Use of the above terms is meant to encompass substituted and unsubstituted moieties. Substitution may be by one or more groups such as alcohols, ethers, esters, amides, sulfones, sulfides, hydroxyl, nitro, cyano, carboxy, amines, heteroatoms, lower alkyl, lower alkoxy, lower alkoxycarbonyl, alkoxyalkoxy, acyloxy, halogens, trifluoromethoxy, trifluoromethyl, alkyl, aralkyl, alkenyl, alkynyl, aryl, cyano, carboxy, carboalkoxy, carboxyalkyl, cycloalkyl, cycloalkylalkyl, heterocyclyl, alkylheterocyclyl, heterocyclylalkyl, oxo, arylsulfonyl and aralkyaminocarbonyl, or any of the substituents of the preceding paragraphs or any of those substituents either directly attached or by suitable linkers. The linkers are typically short chains of 1-3 atoms containing any combination of —C—, —C(O)—, —NH—, —S—, —S(O)—, —O—, —C(O)— or —S(O)O. Rings may be substituted multiple times.

The term “lower” modifying “alkyl”, “alkenyl”, “alkynyl”, “alkoxy” or “alkoxycarbonyl” refers to a C₁-C₆ unit for a particular functionality. For example, “lower alkyl” means C₁-C₆ alkyl.

By “substituted” is meant having one or more substituent moieties whose presence does not interfere with the desired function or reactivity. Examples of substituents alkyl, alkenyl, alkynyl, cycloalkyl (non-aromatic ring), Si(alkyl)₃, Si(alkoxy)₃, alkoxy, amino, alkylamino, alkenylamino, amide, amidine, guanidine, hydroxyl, thioether, alkylcarbonyl, alkylcarbonyloxy, alkoxycarbonyloxy, carbonate, alkoxycarbonyl, aminocarbonyl, alkylthiocarbonyl, phosphate, phosphate ester, phosphonato, cyano, halo, acylamino, imino, sulfhydryl, alkylthio, thiocarboxylate, dithiocarboxylate, sulfate, sulfato, sulfonate, sulfamoyl, sulfonamide, nitro, nitrile, azido, heterocyclyl, ether, ester, silicon-containing moieties, thioester or a combination thereof. The substituents may themselves be substituted. For instance, an amino substituent may itself be mono or independently disubstituted by further substituents defined above, such as alkyl, alkenyl, alkynyl, and cycloalkyl (non-aromatic ring).

By “sulfide” is meant a thioether —S—R′, where R′ may be, but is not limited to, aliphatic groups.

By “sulfhydryl” is meant a thiol i.e. —SH.

By “thiocyanato” is meant —SCN.

By “thioester” is meant —SC(O)R′, where R′ may be, but is not limited to, aliphatic groups.

By “unsubstituted” is meant any open valence of an atom being occupied by hydrogen. Also, if an occupant of an open valence position on an atom is not specified, then it is hydrogen.

As used herein, the terms “top,” “bottom,” “upper,” “lower,” “above,” and “below” are used to provide a relative relationship between structures. The use of these terms does not indicate or require that a particular structure must be located at a particular location in the apparatus.

By “unsaturated” is meant a moiety that contains double or triple carbon-carbon bonds.

By “unsaturated substituent” is meant a double or triple bond containing aliphatic chain, cyclic, aryl or heteroaryl group.

A person of ordinary skill in the art would recognize that the definitions provided above are not intended to include impermissible substitution patterns (e.g. methyl substituted with five substituents and the like). Such impermissible substitution patterns are easily recognized by a person of ordinary skill in the art. Any functional group disclosed herein and/or defined above can be substituted or unsubstituted, unless otherwise indicated herein.

By “leaving group” is meant an atom (or a group of atoms) with electron withdrawing ability that can be displaced as a stable species, taking with it the bonding electrons, or an atom (or a group of atoms) that can be replaced by a substitution reaction. Examples of suitable leaving groups include H, halides, and sulfonates including, but not limited to, triflate (—OTf), mesylate (—OMs), tosylate (—OTs), brosylate (—OBs), acetate, Cl, Br, and I.

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

### Introduction & Context

Compositions and copolymers useful for a membrane electrode assembly (MEA) are described herein. The MEA may be used in a COₓ reduction reactor. COₓ may be carbon dioxide (CO₂), carbon monoxide (CO), CO₃²⁻ (carbonate ion), HCO₃⁻ (bicarbonate ion), or combinations thereof. The MEA contains an anode layer, a cathode layer, electrolyte, and optionally one or more other layers. The layers may be solids and/or soft materials. The layers may include polymers such as ion-conducting polymers.

When in use, the cathode of an MEA promotes electrochemical reduction of COₓ by combining three inputs: COₓ, ions (e.g., protons) that chemically react with COₓ, and electrons. The reduction reaction may produce CO, hydrocarbons, and/or oxygen and hydrogen containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

The compositions and arrangements of layers in the MEA may promote high yield of a COₓ reduction products. To this end, the MEA may facilitate any one or more of the following conditions: (a) minimal parasitic reduction reactions (non-COₓ reduction reactions) at the cathode; (b) low loss of COₓ reactants at anode or elsewhere in the MEA; (c) maintain physical integrity of the MEA during the reaction (e.g., prevent delamination of the MEA layers); (d) prevent COₓ reduction product cross-over; (e) prevent oxidation production (e.g., O₂) cross-over; (f) maintain a suitable environment at the cathode/anode for oxidation/reduction as appropriate; (g) provide pathway for desired ions to travel between cathode and anode while blocking undesired ions; and (h) minimize voltage losses.

Polymer-based membrane assemblies such as MEAs have been used in various electrolytic systems such as water electrolyzers and in various galvanic systems such as fuel cells. However, COₓ reduction presents problems not encountered, or encountered to a lesser extent, in water electrolyzers and fuel cells.

For example, for many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large geometric surface area by comparison to MEAs used for fuel cells in automotive applications. For example, MEAs for COₓ reduction may employ electrodes having geometric surface areas (without considering pores and other nonplanar features) of at least about 500 cm².

COₓ reduction reactions may be implemented in operating environments that facilitate mass transport of particular reactant and product species, as well as to suppress parasitic reactions. Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

In some systems, the rate of a COₓ reduction reaction is limited by the availability of gaseous COₓ reactant at the cathode. By contrast, the rate of water electrolysis is not significantly limited by the availability of reactant: liquid water tends to be easily accessible to the cathode and anode, and electrolyzers can operate close to highest current density possible.

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication, which would produce a short circuit. The cathode layer includes a reduction catalyst and a first ion-conducting polymer. The cathode layer may also include an ion conductor and/or an electron conductor. The anode layer includes an oxidation catalyst and a second ion-conducting polymer. The anode layer may also include an ion conductor and/or an electron conductor. The PEM includes a third ion-conducting polymer.

In certain embodiments, the MEA has a cathode buffer layer between the cathode layer and the polymer electrolyte membrane. The cathode buffer includes a fourth ion-conducting polymer.

In certain embodiments, the MEA has an anode buffer layer between the anode layer and the polymer electrolyte membrane. The anode buffer includes a fifth ion-conducting polymer.

In connection with certain MEA designs, there are three available classes of ion-conducting polymers: anion-conductors, cation-conductors, and mixed cation-and-anion-conductors. In certain embodiments, at least two of the first, second, third, fourth, and fifth ion-conducting polymers are from different classes of ion-conducting polymers.

In other embodiments, at least two of the first, second, third, and fourth ion-conducting polymers are from different classes of ion-conducting polymers. There are three classes of ion-conducting polymers: anion-conductors, cation-conductors, and cation-and-anion-conductors. The ionic or ionizable moiety can be selected to provide any one of these classes.

The term, “ion-conducting polymer” is used herein to describe a polymer electrolyte having greater than approximately 1 mS/cm specific conductivity for anions and/or cations. The term, “anion-conductor” and/or “anion-conducting polymer” describes an ion-conducting polymer that conducts anions primarily (although there will still be some small amount of cation conduction) and has a transference number for anions greater than approximately 0.85 at around 100 micron thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at around 100 micron thickness. For an ion-conducting polymer that is described as conducting both anions and cations (a “cation-and-anion-conductor”), neither the anions nor the cations has a transference number greater than approximately 0.85 or less than approximately 0.15 at around 100 micron thickness. To say a material conducts ions (anions and/or cations) is to say that the material is an ion-conducting material.

In certain embodiments, the polymers disclosed herein can be represented by the following general formula: P1-L-P2 (I), or a salt thereof, wherein P1 is an ionomer having an aromatic hydrocarbon-containing backbone and an amine-containing ionizable moiety or an amine-containing ionic moiety; and P2 is a styrene-based copolymer having a hydrocarbon backbone and pendant optionally substituted phenyl rings; L is a linking moiety or a covalent bond. The polymers are ion-conducting materials.

When the ionomer and the styrene-based copolymer are combined, they may have beneficial chemical and physical properties (e.g., beneficial ion exchange capacity (IEC), ionic conductivity, water uptake, swelling degree, specific conductivity, mechanical stability, etc.). Without wishing to be bound by theory, combining the two types of polymers may induce a phase separation effect which can influence control of membrane channel size and/or ion transport properties in certain embodiments.

The selection of particular polymer components (e.g., first structure, second structure, polymeric units, ionic moieties, crosslinkers, etc.) can provide useful properties for the composition. In one instance, polymer components can be selected to minimize water uptake, in which excessive water can result in flooding of an electrochemical cell. In another instance, polymer components can be selected to provide resistance to softening or plasticization. In other embodiments, the composition can be an ion-conducting polymer having greater than about 1 mS/cm specific conductivity for anions and/or cations.

The ionomer and the styrene-based copolymer may be combined in a number of ways, depending upon the linking moiety and the location of the linkage. In one embodiment, the two component polymers can be joined through a linking moiety which connects the two of them, such as with a bifunctional reactant. For example, the linking moiety may join the aromatic hydrocarbon-containing backbone of the ionomer to the hydrocarbon backbone of the styrene-based copolymer or joined through a side chain of the ionomer and a phenyl ring substituent of the polystyrene. The combining may include an ionic moiety of one of the polymers, or be between two ionic moieties—one on the ionomer and one on the polystyrene.

The linking moiety may be a bifunctional moiety having two reactive ends linked by a spacer, wherein the spacer includes optionally substituted alkyl, optionally substituted aryl or optionally substituted heterocyclyl. Each reactive end of the space may be the same functional group, or a different functional group. Representative functional groups include, but are not limited to ethers, esters, carbamate esters, amides, amines, ketones, epoxides, heterocycles or thioethers.

Branched polymers of the general formula XII illustrate this embodiment.

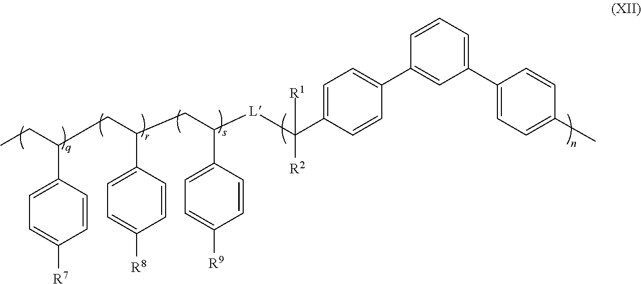

Branched polymers of general formula (XII) include salts thereof, wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety; R⁷, R⁸ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷, R⁸ and R⁹ is or includes an ionizable moiety or an ionic moiety; L′ is a linking moiety and wherein the linking moiety is a bifunctional moiety having two reactive ends linked by a spacer; n is an integer of 1 or more; and each occurrence of q, r and s is independently an integer of 1 or more.

In another embodiment, the two component polymers can combined by directly joining them together through a covalent bond which connects the two of them to form another type of branched polymer. For example, the covalent bond may join the aromatic hydrocarbon-containing backbone of the ionomer to a pendant optionally substituted phenyl ring of the styrene-based copolymer.

Branched polymers of the general formula XIII illustrate this embodiment.

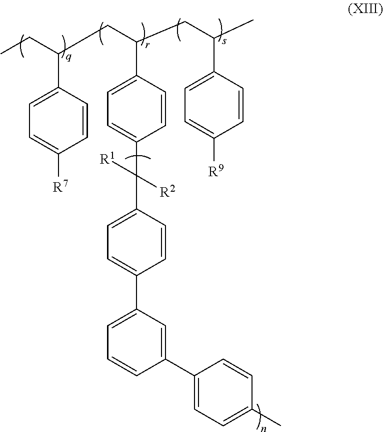

Branched polymers of general formula (XIII) include salts thereof, wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety; R⁷ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷ and R⁹ is or includes an ionizable moiety or an ionic moiety; n is an integer of 1 or more; and each occurrence of q, r and s is independently an integer of 1 or more.

In yet another embodiment, the two component polymers can be crosslinked or joined together by a linking moiety which connects the two of them through each of their side chains. For example, the linking moiety may join the side chain of the ionomer comprising the amine-containing ionizable moiety or the amine-containing ionic moiety to a pendant optionally substituted phenyl ring of the styrene-based copolymer. Crosslinked polymers of the general formula XIV illustrate this embodiment.

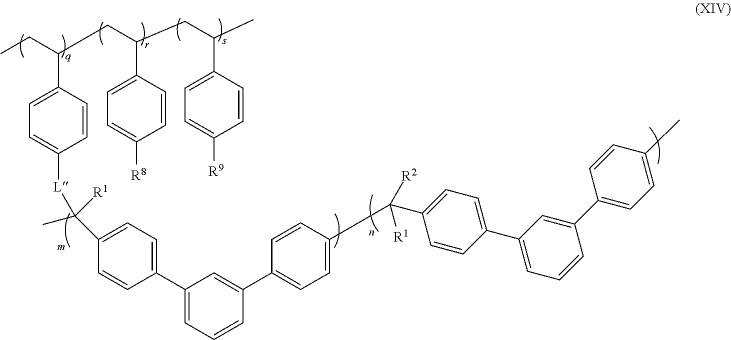

Crosslinked polymers of general formula (XIV) include salts thereof, wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety; R⁸ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁸ and R⁹ is or includes an ionizable moiety or an ionic moiety; L″ is a linking moiety and wherein the linking moiety is a bifunctional moiety having two reactive ends linked by a spacer; each occurrence of m and n is independently an integer of 1 or more; and each occurrence of q, r and s is independently an integer of 1 or more.

The disclosed ion-conducting crosslinked polymers which can be advantageously utilized for MEAs are described in greater detail below.

### The Ionomers

In certain embodiments, the ionomer is a polymer which has an aromatic hydrocarbon-containing backbone and an amine-containing ionizable moiety or an amine-containing ionic moiety. The ionomers are also referred to herein variously as “the first polymer” or “the first structure”.

Within the composition, the first structure can include a polymeric unit, which in turn can include one or more ionizable or ionic moieties. In non-limiting embodiments, the polymeric unit can have an arylene-containing backbone, which provides an organic scaffold upon which ionizable/ionic moieties can be added.

Particular moieties herein (e.g., polymeric units, linking moieties, and others) can include an optionally substituted arylene. Such arylene groups include any multivalent (e.g., bivalent, trivalent, tetravalent, etc.) groups having one or more aromatic groups, which can include heteroaromatic groups. Non-limiting aromatic groups can include any of the following:

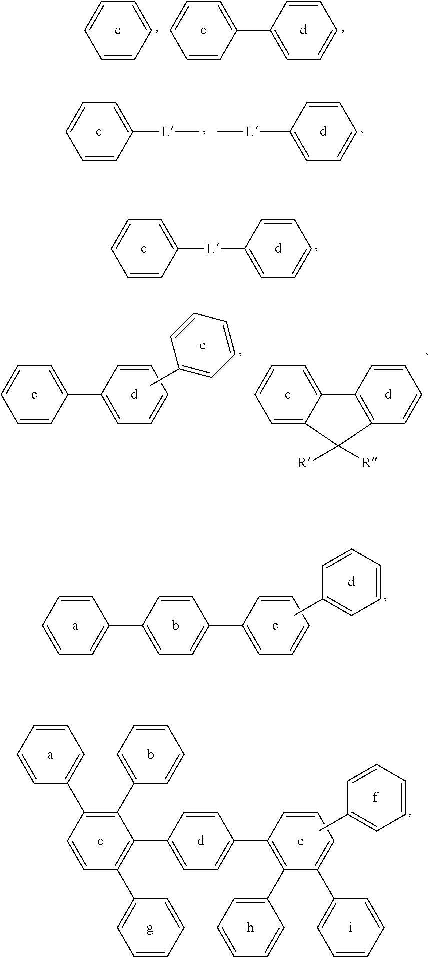

in which each of rings a-i can be optionally substituted (e.g., with any optional substituents described herein for alkyl or aryl; or with any ionic moiety described herein); L′ is a linking moiety (e.g., any described herein); and each of R′ and R″ is, independently, H, optionally substituted alkyl, optionally substituted aryl, or an ionic moiety, as described herein. Non-limiting substituents for rings a-i include one or more described herein for aryl, such as alkyl, alkoxy, alkoxyalkyl, amino, aminoalkyl, aryl, arylalkylene, aryloyl, aryloxy, arylalkoxy, cyano, hydroxy, hydroxyalkyl, nitro, halo, and haloalkyl. In some embodiments, L′ is a covalent bond, —O—, —NR^{N1}—, —C(O)—, optionally substituted alkylene, optionally substituted heteroalkylene, or optionally substituted arylene. Yet other non-limiting arylene can include phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), 9,10-anthracene, naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like.

Non-limiting examples of linking moieties for arylene include any herein. In some embodiments, L′ is substituted one or more ionizable or ionic moieties described herein. In particular embodiments, L′ is optionally substituted alkylene. Non-limiting substitutions for L′ can include -L^{A}-X^{A}, in which L^{A} is a linking moiety (e.g., any described herein, such as, -Ak-, —O-Ak-, -Ak-O—, —Ar—, —O—Ar—, or —Ar—O—, in which Ak is optionally substituted alkylene and Ar is optionally substituted arylene), and X^{A} is an acidic moiety, a basic moiety, or a multi-ionic moiety.

An arylene-containing backbone can also provide an aromatic group that facilitates the addition of a reactive carbocation (e.g., by reacting with a Friedel-Crafts alkylation reagent). In this way, monomeric units having aromatic groups can be reacted together to form a polymeric unit. Such addition/polymerization reactions can be promoted in any useful manner, e.g., by including an electron-withdrawing group in proximity to that carbocation. Thus, in some non-limiting instances, the first structure can include both optionally substituted aromatic groups and electron-withdrawing groups.

The reactive carbocation can also provide functional groups that can be further modified. For instance, the reactive carbocation can be attached to a -L^{A}-R^{G} group, in which L^{A} is a linking moiety (e.g., any herein) and R^{G} is a reactive group (e.g., halo). After adding the carbocation and -L^{A}-R^{G} group to the polymeric unit, the R^{G} group can be further reacted with an ionizable reagent (e.g., such as an amine, NR^{N1}R^{N2}R^{N3}) to provide an ionic moiety (e.g., such as an ammonium, N⁺R^{N1}R^{N2}R^{N3}).

Accordingly, in some non-limiting embodiments, the first structure includes a polymeric unit (e.g., any described herein) having an ionizable/ionic moiety and an electron-withdrawing group. In some instances, the polymeric unit is formed by using one or more monomeric units. Non-limiting monomeric units can include one or more of the following:

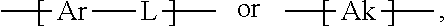

in which Ar is an optionally substituted arylene or optionally substituted aromatic; Ak is an optionally substituted alkylene, optionally substituted haloalkylene, optionally substituted heteroalkylene, optionally substituted aliphatic, or optionally substituted heteroaliphatic; and L is a linking moiety (e.g., any described herein) or can be —C(R⁷)(R⁸)— (e.g., for any R⁷ and R⁸ groups described herein). In particular examples, Ar, L, and/or Ak can be optionally substituted with one or more ionizable or ionic moieties and/or one or more electron-withdrawing groups.

In some embodiments, the ionomer (or first structure) includes a polymeric unit selected from the following:

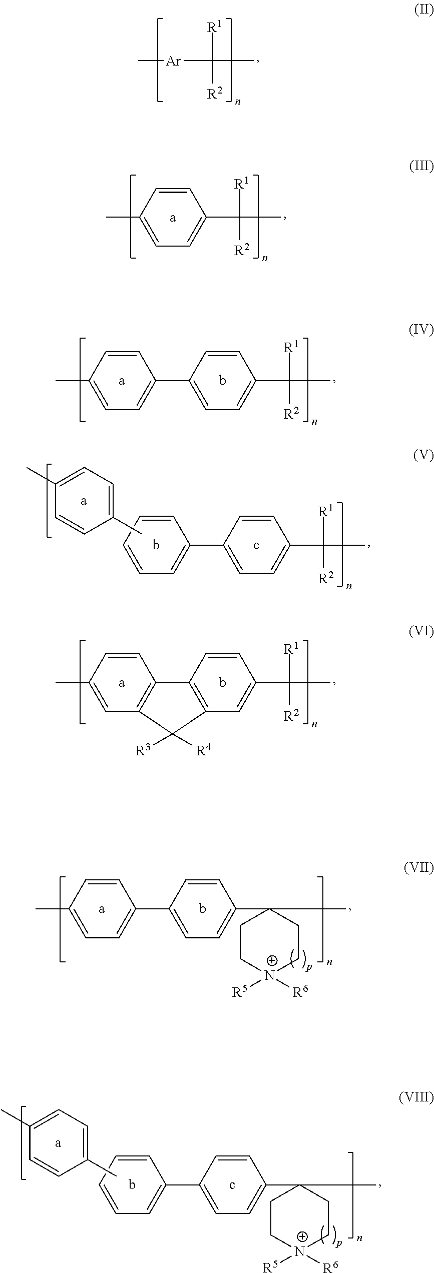

or a salt thereof,
wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety; R³ and R⁴ each independently comprise H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R³ and R⁴ can be taken together to form an optionally substituted cyclic group;
R⁵ and R⁶ each independently comprise H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁵ and R⁶ can be taken together to form an optionally substituted cyclic group; Ar includes or is an optionally substituted aromatic or optionally substituted arylene; n is an integer of 1 or more; p is 0, 1, 2, or more; and each of ring a, ring b, and ring c may independently be optionally substituted with one or more substituents comprising alkyl, alkoxy, amino, aminoalkyl, aryl, arylalkenyl, aryoyl, aryloxy, arylalkoxy, cyano, hydroxy, hydroxyalkyl, nitro, halo or haloalkyl; and wherein at least one of rings a-c, R¹, R², R³, and R⁴ of formulas (II)—(VI) is or includes an amine-containing ionizable moiety or an amine-containing ionic moiety.

With regard to structure (V), the a ring may be substituted on the bring at the ortho, meta or para position of the b ring.

Further substitutions for ring a, ring b, ring c, and/or R¹-R⁶ can include one or more optionally substituted arylene, as well as any described herein for alkyl or aryl. Non-limiting examples of Ar include, e.g., phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), triphenylene, diphenyl ether, anthracene (e.g., 9,10-anthracene), naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like, as well as others described herein.

The first structure can include polymeric units having an electron-withdrawing moiety and a fluorenyl-based backbone. For instance, the first structure can include a polymeric unit as follows:

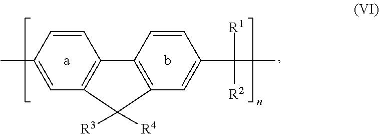

or a salt thereof, wherein:
each of R¹ and R² is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, wherein at least one of R¹ or R² includes the electron-withdrawing moiety or wherein R¹ and R² can be taken together to form an optionally substituted cyclic group; each of R³ and R⁴ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R³ and R⁴ can be taken together to form an optionally substituted cyclic group; n is, independently, an integer of 1 or more; each of ring a, ring b, and/or ring c can be optionally substituted; and wherein one or more of rings a-b, R⁷, R⁸, R⁹, and R¹⁰ can optionally include an ionizable moiety or an ionic moiety.

In particular embodiments, each of R³ and R⁴ includes, independently an amine-containing ionizable moiety or an amine-containing ionic moiety.

The amine-containing ionic moiety includes optionally substituted pyrazolium, optionally substituted pyridinium, optionally substituted pyrazinium, optionally substituted pyrimidinium, optionally substituted pyridazinium, optionally substituted piperidinium, optionally substituted pyrrolidinium, optionally substituted indolizinium, optionally substituted isoindolium, optionally substituted indazolium, optionally substituted imidazolium, optionally substituted oxazolium, optionally substituted triazolium, optionally substituted tetrazolium, optionally substituted thiazolium, optionally substituted purinium, optionally substituted isoquinolinium, optionally substituted quinolinium, optionally substituted phthalazinium, optionally substituted quinooxalinium, optionally substituted phenazinium, optionally substituted morpholinium, immonium, ammonium, guanidinium or histidinium.

In one embodiment, the amine-containing ionizable moiety or an amine-containing ionic moiety includes, but is not limited to, a structure of formula (X):

—(C(R¹⁰)₂)ₜR¹¹ (X),

wherein each R¹⁰ independently comprises H, aliphatic, aralkyl, aryl, heteroaryl, alkoxy, aryloxy, thioalkyl, thioaralkyl, thioaryl, aminoalkyl, amino, aminoaryl, halo or hydroxyl; R¹¹ comprises amino or nitrogen-containing heterocyclyl; and t is an integer of 1 to 30.

In another embodiment, the amine-containing ionizable moiety or an amine-containing ionic moiety includes, but is not limited to, a structure of formula a structure of formula (XI):

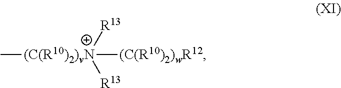

wherein each R¹⁰ independently comprises H, alkyl, aralkyl, aryl, heteroaryl, alkoxy, aryloxy, thioalkyl, thioaralkyl, thioaryl, aminoalkyl, amino, aminoaryl, halo or hydroxyl; R¹² comprises amino, aryl, heterocyclyl, hydroxyl, dihydroxyl, sulfhydryl, sulfide, disulfide, sulfo, or thioester; each R¹³ independently comprises H or aliphatic; v is an integer of 1 to 30; and w is an integer of 1 to 10.

In some embodiments, the percentage of amine-containing ionizable moieties or an amine-containing ionic moieties ranges from about 5% to about 99% or from about 20% to about 80%.

In some embodiments, the ionomer includes one or more different amine-containing ionizable moieties or an amine-containing ionic moieties. Other appropriate nitrogen-containing ionizable or ionic moieties are described in greater detail below.

In some embodiments (e.g., of formulas (II)—(VIII)), ring a, ring b, and/or ring c includes an ionizable moiety or an ionic moiety. In other embodiments, R² includes an ionizable moiety or an ionic moiety. In particular embodiments, the ionic moiety includes or is -L^{A}-X^{A}, in which L^{A} is a linking moiety (e.g., optionally substituted aliphatic, alkylene, heteroaliphatic, heteroalkylene, aromatic, or arylene); and X^{A} is an acidic moiety, a basic moiety, a multi-ionic moiety, a cationic moiety, or an anionic moiety. Non-limiting examples of X^{A} include amino, ammonium cation, heterocyclic cation, piperidinium cation, azepanium cation, phosphonium cation, phosphazenium cation, or others herein.

In other embodiments (e.g., of formulas (II)—(VI)), R¹ includes the electron-withdrawing moiety. Non-limiting electron-withdrawing moieties can include or be an optionally substituted haloalkyl, cyano (CN), phosphate (e.g., —O(P=O)(OR^{P1})(OR^{P2}) or —O—[P(═O)(OR^{P1})—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (—B(OH)₂), thiocyanato (—SCN), or piperidinium. In further embodiments, R¹ includes the electron-withdrawing moiety, and R² includes the ionizable/ionic moiety. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

In some embodiments (e.g., for any structure herein, such as in formulas (II)—(VI)), R¹ includes an optionally substituted aliphatic group. In one embodiment, R¹ includes an optionally alkyl group.

In other embodiments (e.g., for any structure herein, such as in formulas (II)—(VI)), R² includes an optionally substituted aliphatic group or an optionally substituted heteroaliphatic group. In particular embodiments, the aliphatic or heteroaliphatic group is substituted with an oxo group (═O) or an hydroxyimino group (=N—OH). In one embodiment, R¹ is —C(═X)—R^{8′}, in which X is O or N—OH; and R^{8′} is optionally substituted aliphatic, optionally substituted alkyl, optionally substituted heteroaliphatic, optionally substituted heteroalkyl, optionally substituted alkoxy, optionally substituted haloalkyl, or optionally substituted alkanoyl.

In yet other embodiments (e.g., for any structure herein, such as in formulas (II)—(VI)), R¹ and R² are taken together to form an optionally substituted cyclic group. For instance, R¹ and R² can be taken together to form an optionally substituted spirocyclyl group, as defined herein. In particular embodiments, the spirocyclyl group is substituted, independently, with one or more ionizable moieties or ionic moieties (e.g., any described herein). In some embodiments, the formulas of (II)—(VI) can be represented as follows:

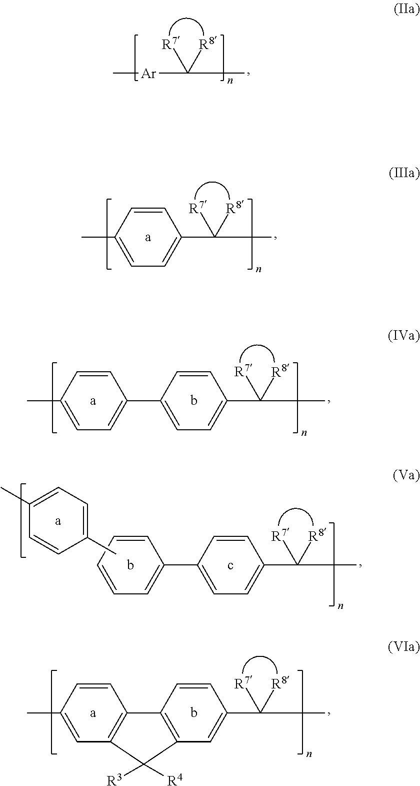

or a salt thereof, wherein R^{7′} and R^{8′} are taken together to form an optionally substituted alkylene group or an optionally substituted heteroalkylene group. In particular embodiments, the optionally substituted alkylene group or the optionally substituted heteroalkylene group is substituted, independently, with one or more ionizable moieties or ionic moieties.

Further non-limiting polymeric units can include a structure of any one or more of the following:

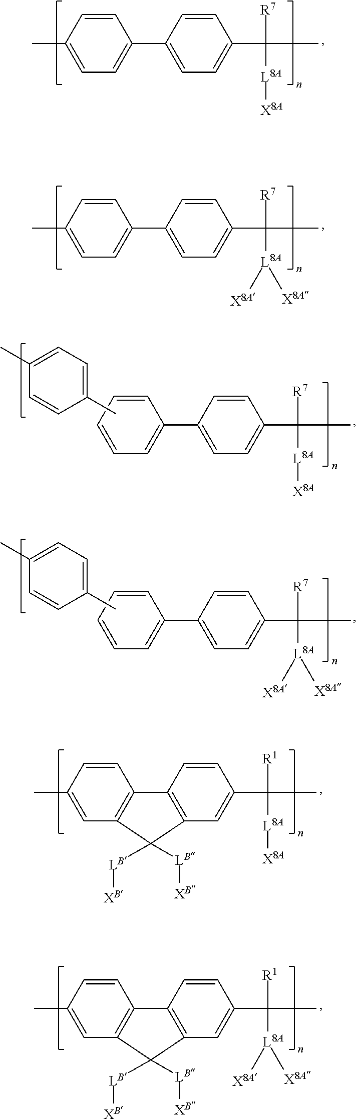

or a salt thereof, wherein:
n is from 1 or more;
each L^{8A}, L^{B′}, and L^{B″} is, independently, a linking moiety; and
each X^{8A}, X^{8A′}, X^{8A″}, X^{B′}, and X^{B″} is, independently, an acidic moiety or a basic moiety.

In any embodiment herein, ring a, ring b, ring c, Ak, R⁷, R⁸, R⁹, and R¹⁰ can optionally include an ionizable moiety or an ionic moiety. Further substitutions for ring a, ring b, ring c, R⁷, R⁸, R⁹, and R¹⁰ can include one or more optionally substituted arylene.

In any embodiment herein, the electron-withdrawing moiety can be an optionally substituted haloalkyl (e.g., C₁₋₆ haloalkyl, including halomethyl, perhalomethyl, haloethyl, perhaloethyl, and the like), cyano (CN), phosphate (e.g., —O(P=O)(OR^{P1})(OR^{P2}) or —O—[P(═O)(OR^{P1})—O]P₃—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (B(OH)₂), thiocyanato (—SCN), or piperidinium. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

In some embodiments (e.g., for any structure herein, such as in formulas (II)—(VIII)), non-limiting haloalkyl groups include fluoroalkyl (e.g., —CₓF_{y}H_{z}), perfluoroalkyl (e.g., —CₓF_{y}), chloroalkyl (e.g., —CₓCl_{y}H_{z}), perchloroalkyl (e.g., —CₓCl_{y}), bromoalkyl (e.g., —CₓBr_{y}H_{z}), perbromoalkyl (e.g., —CₓBr_{y}), iodoalkyl (e.g., —CₓI_{y}H_{z}), or periodoalkyl (e.g., —CₓI_{y}). In some embodiments, x is from 1 to 6, y is from 1 to 13, and z is from 0 to 12. In particular embodiments, z=2x+1−y. In other embodiments, x is from 1 to 6, y is from 3 to 13, and z is 0 (e.g., and y=2x+1).

The polymeric unit can include one or more substitutions to a ring portion of the unit (e.g., as provided by an aromatic or arylene group) or to a linear portion (e.g., as provided by an aliphatic or alkylene group). Non-limiting substitutions can include lower unsubstituted alkyl (e.g., C₁₋₆ alkyl), lower substituted alkyl (e.g., optionally substituted C₁₋₆ alkyl), lower haloalkyl (e.g., C₁₋₆ haloalkyl), halo (e.g., F, Cl, Br, or I), unsubstituted aryl (e.g., phenyl), halo-substituted aryl (e.g., 4-fluoro-phenyl), substituted aryl (e.g., substituted phenyl), and others.

### The Styrene-Based Copolymers

As used herein, “polystyrene” refers to styrene-based copolymers, which are copolymers prepared from monomers of styrene (having the chemical formula C₆H₅CH═CH₂) and substituted derivatives thereof. Two, three or more different styryl-containing monomers may be combined to form the copolymers which are optionally substituted from their pendent phenyl groups. In some embodiments, the copolymers are terpolymers formed from three different styrene-based monomers which may be substituted or unsubstituted.

The styrene-based copolymers are also referred to herein variously as “the second polymer” or “the second structure”. In certain embodiments, the styrene-based copolymer comprises a structure of formula (IX):

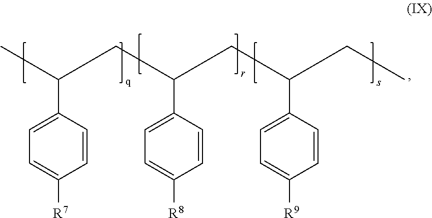

wherein R⁷, R⁸ and R⁹ are each independently H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷, R⁸ and R⁹ is or includes an ionizable moiety or an ionic moiety; and each occurrence of q, r and s is independently an integer of 1 or more.

In some embodiments, the percentage of ionizable moieties or ionic moieties ranges from about 5% to about 99% or from about 20% to about 80%. In some embodiments, the polystyrene includes a substituent which has an amine-containing ionizable moiety or an amine-containing ionic moiety as the ionizable or ionic moiety, which may be the same amine-containing ionizable moiety or amine-containing ionic moiety as that of the ionomer which it is linked to; or a different amine-containing ionizable moiety or amine-containing ionic moiety than that of the ionomer which it is crosslinked to.

Suitable ionizable moieties or ionic moieties are described in greater detail below. In some embodiments, the moieties include, but are not limited to, optionally substituted pyrazolium, optionally substituted pyridinium, optionally substituted pyrazinium, optionally substituted pyrimidinium, optionally substituted pyridazinium, optionally substituted piperidinium, optionally substituted pyrrolidinium, optionally substituted indolizinium, optionally substituted isoindolium, optionally substituted indazolium, optionally substituted imidazolium, optionally substituted oxazolium, optionally substituted triazolium, optionally substituted tetrazolium, optionally substituted thiazolium, optionally substituted purinium, optionally substituted isoquinolinium, optionally substituted quinolinium, optionally substituted phthalazinium, optionally substituted quinooxalinium, optionally substituted phenazinium, optionally substituted morpholinium, immonium, ammonium, guanidinium or histidinium.

### Ionizable and Ionic Moieties

The compositions disclosed herein can include one or more ionizable or ionic moieties. As described herein, the ionizable or ionic moieties may be part of or attached to the ionomer (first polymer), the styrene-based copolymer (the second polymer) or both the ionomer and the styrene-based copolymer. Such moieties can include an anionic or cationic charge, such as in an ionic moiety. Alternatively, an ionizable moiety includes a functional group that can be readily converted into an ionic moiety, such as an ionizable moiety of a carboxy group (—CO₂H) that can be readily deprotonated to form a carboxylate anion (—CO₂⁻). As used herein, the terms “ionizable” and “ionic” are used interchangeably.

Moieties can be characterized as an acidic moiety (e.g., a moiety can be deprotonated or can carry a negative charge) or a basic moiety (e.g., a moiety that can be protonated or carry a positive charge). In particular embodiments, the moiety can be a multi-ionic moiety, which can include a plurality of acidic moieties, a plurality of basic moieties, or a combination thereof (e.g., such as in a zwitterionic moiety). Further moieties can include a zwitterionic moiety, such as those including an anionic moiety (e.g., hydroxyl or a deprotonated hydroxyl) and a cationic moiety (e.g., ammonium).

The ionic moieties herein can be connected to the parent structure by way of one or more linking moieties. Furthermore, a single ionic moiety can be extended from a single linking moiety, or a plurality of ionic moieties can have one or more linking moieties therebetween.

For instance, the ionic moiety can have any of the following structures: -L^{A}-X^{A} or -L^{A}-(L^{A′}-X^{A})_{L2} or -L^{A}-(X^{A}-L^{A′}-X^{A′})_{L2} or -L^{A}-X^{A}-L^{A′}-X^{A′}-L^{A″}-X^{A}, in which each L^{A}, L^{A′}, and L^{A″} is a linking moiety; each X^{A}, X^{A′}, and X^{A″} includes, independently, an acidic moiety, a basic moiety, or a multi-ionic moiety; and L2 is an integer of 1, 2, 3, or more (e.g., from 1 to 20).

Non-limiting linking moieties (e.g., for L^{A}, L^{A′}, and L^{A″}) include a covalent bond, a spirocyclic bond, —O—, —NR^{N1}—, —SO₂—NR^{N1}-Ak-, —(O-Ak)_{L1}-SO₂—NR^{N1}-Ak-, -Ak-, -Ak-(O-Ak)_{L1}-, —(O-Ak)_{L1}-, -(Ak-O)_{L1}—, —C(O)O-Ak-, —Ar—, or —Ar—O—, in which Ak is an optionally substituted alkylene or optionally substituted haloalkylene, R^{N1} is H or optionally substituted alkyl, Ar is an optionally substituted arylene, and L1 is an integer from 1 to 3. In particular embodiments, L^{A} is —(CH₂)_{L1}—, —O(CH₂)_{L1}—, —(CF₂)_{L1}—, —O(CF₂)_{L1}—, or —S(CF₂)_{L1}—, in which L1 is an integer from 1 to 3.

In some instances, a linker is attached to two or more ionic moieties. In some embodiments, the ionic moiety can be -L^{A}-(L^{A′}-X^{A})_{L2}, in which L^{A} and L^{A′} are linking moieties and X^{A} is an acidic moiety, a basic moiety, or a multi-ionic moiety. In one instance, L^{A} provides one, two, or three linkages. Non-limiting L^{A} can be —CX₂(CX₂—), —CX(CX₂—)₂, or —C(CX₂—)₃, in which X is H, alkyl, or halo. L^{A′} can then provide an attachment point to the ionic moiety. For instance, L^{A1′} can be —(CH₂)_{L1}—, —O(CH₂)_{L1}—, —(CF₂)_{L1}—, —O(CF₂)_{L1}—, or —S(CF₂)_{L1}—, in which L1 is an integer from 1 to 3; and X^{A} is any ionizable or ionic moiety described herein.

Non-limiting ionic moieties include carboxy (—CO₂H), carboxylate anion (—CO₂⁻), a guanidinium cation (e.g., —NR^{N1}—C(=NR^{N2}R^{N3})(NR^{N4}R^{N5}) or >N=C(NR^{N2}R^{N3})(NR^{N4}R^{N5})), or a salt form thereof. Non-limiting examples of each of R^{N1}, R^{N2}, R^{N3}, R^{N4}, and R^{N5} is, independently, H, optionally substituted alkyl, optionally substituted aryl, or optionally substituted amino; or R^{N1} and R^{N2}, R^{N2} and R^{N3}, R^{N3} and R^{N4}, R^{N1} and R^{N2}, or R^{N1} and R^{N4} taken together with the nitrogen atom to which each are attached, form an optionally substituted heterocyclyl, heterocycle, or heterocyclic cation, as defined herein.

Some ionic moieties can include one or more sulfur atoms. Non-limiting sulfur-containing moieties include sulfo (—SO₂OH), sulfonate anion (—SO₂O⁻), sulfonium cation (e.g., —SR^{S1}R^{S2}), sulfate (e.g., —O—S(═O)₂(OR^{S1})), sulfate anion (—O—S(═O)₂O⁻), or a salt form thereof. Non-limiting examples of each of R^{S1} and R^{S2} is, independently, H, optionally substituted alkyl, optionally substituted aryl, or optionally substituted amino; or R^{S1} and R^{S2}, taken together with the sulfur atom to which each are attached, form an optionally substituted heterocyclyl, heterocycle, or heterocyclic cation, as defined herein; or R^{S1} and R^{S2}, taken together, form an optionally substituted alkylene or heteroalkylene (e.g., as described herein).

Other ionic moieties can include one or more phosphorous atoms. Non-limiting phosphorous-containing moieties include phosphono (e.g., —P(═O)(OH)₂), phosphonate anion (e.g., —P(═O)(O⁻)₂ or —P(═O)(OH)(O⁻)), phosphate (e.g., —O—P(═O)(OR^{P1})(OR^{P2}) or —O—[P(═O)(OR^{P1})—O]P₃—R^{P2}), phosphate anion (e.g., —O—P(═O)(OR^{P1})(O⁻) or —O—P(═O)(O⁻)₂), phosphonium cation (e.g., —P⁺R^{P1}R^{P2}R^{P3}), phosphazenium cation (e.g., —P⁺(=NR^{N1}R^{N2})R^{P1}R^{P2}, in which each of R^{N1} and R^{N2} is, independently, optionally substituted alkyl or optionally substituted aryl), or a salt form thereof. Non-limiting examples of each of R^{P1}, R^{P2}, and R^{P3} is, independently, H, optionally substituted alkyl, optionally substituted aryl, or optionally substituted amino; or R^{P1} and R^{P2}, taken together with the phosphorous atom to which each are attached, form an optionally substituted heterocyclyl, heterocycle, or heterocyclic cation, as defined herein; or R^{P1} and R^{P2} and R^{P3}, taken together with the phosphorous atom to which each are attached, form an optionally substituted heterocyclyl, heterocycle, or heterocyclic cation, as defined herein; or a single, double, or non-localized pi bond, provided that a combination of bonds result in a tetravalent phosphorous; or wherein two of R^{P1}, R^{P2}, and R^{P3}, taken together, form an optionally substituted alkylene or heteroalkylene (e.g., as described herein).

Yet other ionic moieties can include one or more nitrogen atoms. Non-limiting nitrogen-containing moieties include amino (e.g., —NR^{N1}R^{N2}), ammonium cation (e.g., —N⁺R^{N1}R^{N2}R^{N3} or —N⁺R^{N1}R^{N2}—), heterocyclic cation (e.g., piperidinium, 1,1-dialkyl-piperidinium, pyrrolidinium, 1,1-dialkyl-pyrrolidinium, pyridinium, 1-alkylpyridinum, (1,4-diazabicyclo[2.2.2]octan-1-yl) (DABCO), 4-alkyl-(1,4-diazabicyclo[2.2.2]octan-1-yl), etc.), or a salt form thereof. Non-limiting examples of each of R^{N1}, R^{N2}, and R^{N3} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl, heterocycle, or heterocyclic cation, as defined herein; or R^{N1} and R^{N2} and R^{N3}, taken together with the nitrogen atom to which each are attached, form an optionally substituted heterocyclyl, heterocycle, or heterocyclic cation, as defined herein; or wherein two of R^{N1}, R^{N2}, and R^{N3}, taken together, form an optionally substituted alkylene or heteroalkylene (e.g., as described herein); or a single, double, or non-localized pi bond, provided that a combination of bonds result in a tetravalent nitrogen.

Yet other heterocyclic cations include piperidinium cations, such as dimethyl piperidinium, methyl piperidinium (e.g., 1-methyl-piperidinium-1-yl), ethylmethyl piperidinium, ethyl piperidinium (e.g., 1-ethyl-piperidinium-1-yl), propylmethyl piperidinium, propyl piperidinium (e.g., 1-propyl-piperidinium-1-yl), butylmethyl piperidinium, butyl piperidinium (e.g., 1-butyl-piperidinium-1-yl), diethyl piperidinium, propylethyl piperidinium, butylethyl piperidinium, butylpropyl piperidinium, or spiro-1,1′-bipiperidinium; pyrrolidinium cations, such as dimethyl pyrrolidinium, ethylmethyl pyrrolidinium, propylmethyl pyrrolidinium, butylmethyl pyrrolidinium, diethyl pyrrolidinium, propylethyl pyrrolidinium, butylethyl pyrrolidinium, butylpropyl pyrrolidinium, spiro-1,1′-bipyrrolidinium, spiro-1-pyrrolidinium-1′-piperidinium, or spiro-1-pyrrolidinium-1′-morpholinium; pyrazolium cations, such as dimethyl pyrazolium, ethylmethyl pyrazolium, or butylmethyl pyrazolium; imidazolium cations, such as 3-alkyl imidazolium, 1,2-dialkylimidazolium, such as 1,2-dimethyl-1H-imidazol-3-ium; those having one nitrogen and five or six carbon ring members, such as pyridinium, 2-methylpyridinium, 3-methylpyridinium, 4-methylpyridinium, 2,6-dimethylpyridinium, quinolinium, isoquinolinium, acridinium, or phenanthridinium; those having two nitrogen and four carbon ring members, such as pyridazinium, pyrimidinium, pyrazinium or phenazinium; or those having one nitrogen and one oxygen ring member, such as morpholinium, 2-methyl morpholinium, or 3-methyl morpholinium.

Any of the heterocyclic cations can be attached to the polymer either directly or indirectly (e.g., by way of a linker or a linking moiety). Furthermore, any atom within the heterocyclic cation (e.g., within the ring of the heterocyclic cation) can be attached to the polymer. For instance, taking piperidinium as the non-limiting heterocyclic cation, such a cation can be attached to the polymer by way of the cationic center or by way of an atom within the ring, and such attachments can be direct by way of a covalent bond or indirect by way of L^{A} (a linking moiety, such as any described herein):

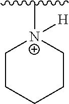 [SMILES: *[NH+]1CCCCC1]

(piperidin-1-ium-1-yl),

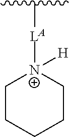

(piperidin-1-ium-1-yl attached by way of L^{A}),

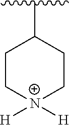 [SMILES: *C1CC[NH2+]CC1]

(piperidin-1-ium-4-yl), or

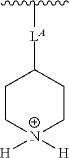

(piperidin-1-ium-4-yl attached by way of L^{A}). In addition to attachment at the 1- or 4-position of piperidin-1-ium, other attachment sites can be implemented at any point on the ring.

In some embodiments, the heterocyclic cations is or comprises a piperidinium cation or an azepanium cation. In one embodiments, the heterocyclic cation includes the following structure:

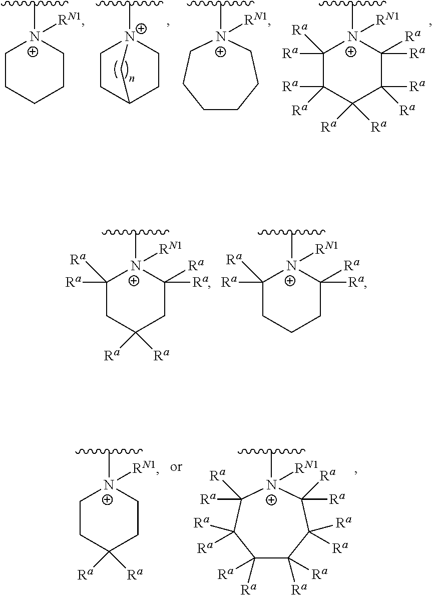

wherein:
R^{N1} is H, optionally substituted aliphatic, optionally substituted alkyl, optionally substituted heteroaliphatic, optionally substituted heteroalkyl, optionally substituted aromatic, or optionally substituted aryl;
n is 1, 2, 3, 4, or 5; and
each R^{a} is, independently, H, optionally substituted aliphatic, optionally substituted alkyl, optionally substituted heteroaliphatic, optionally substituted heteroalkyl, optionally substituted aromatic, optionally substituted aryl, an ionizable moiety, or an ionic moiety;
wherein R^{N1} and at least one R^{a} can be taken together to form an optionally substituted cyclic group or an optionally substituted heterocyclic group, and/or
wherein at least two R^{a} groups can be taken together to form an optionally substituted cyclic group or an optionally substituted heterocyclic group.

In one instance, R^{N1} and R^{a} can be taken together to form an optionally substituted alkylene group or an optionally substituted heteroalkylene group. In particular embodiments, the alkylene or heteroalkylene group is substituted, independently, with one or more ionizable moieties or ionic moieties (e.g., any described herein).

In another instance, at least one R^{a} is optionally substituted aliphatic or optionally substituted alkyl. Non-limiting examples of R^{a} include methyl, ethyl, n-propyl, isopropyl, n-butyl, sec-butyl, isobutyl, tert-butyl, n-pentyl, sec-pentyl, isopentyl, tert-pentyl, neopentyl, 3-pentyl, sec-isopentyl, and the like. In other embodiments, the heterocyclic cation has a ring having one, two, three, four, five, or six R^{a} groups that is not H. In yet other embodiments, the heterocyclic cation has a ring having one, two, three, four, five, or six R^{a} groups that is, independently, optionally substituted aliphatic or optionally substituted alkyl. Without wishing to be limited by mechanism, the presence of bulky substituents may provide more stable cations. In other embodiments, any ionizable moiety or ionic moiety herein can be substituted with one or more R^{a} groups.

Yet other non-limiting piperidinium cations or azepanium cations include any of the following:

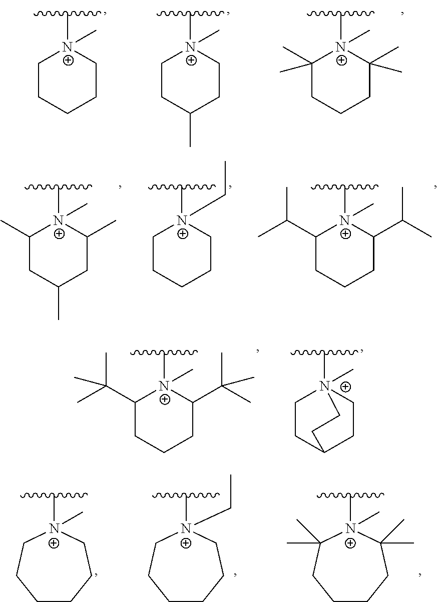

and the like.

Other moieties can include -L^{A}-L^{A}-X^{A}, in which L^{A} is or includes optionally substituted aromatic, optionally substituted arylene, optionally substituted heterocycle, or optionally substituted heterocyclyl (e.g., optionally substituted phenylene or optionally substituted aryleneoxy); L^{A} is or includes optionally substituted aliphatic, optionally substituted alkylene, optionally substituted heteroaliphatic, or optionally substituted heteroalkylene (e.g., optionally substituted C₁₋₆ alkylene or optionally substituted C₁₋₆ heteroalkylene); and X^{A} is or includes an ionic moiety including one or more nitrogen atoms. Non-limiting ionic moieties include pyridinium (e.g., pyridinum-1-yl, Pyrd; alkylpyridinium, such as 2-methylpyridinum-1-yl, 2MPyrd; or aromatic pyridinium, such as 1-benzylpyridinium-4-yl), imidazolium (e.g., 1,2-dialkylimidazolium-3-yl, including 1,2-dimethylimidazolium-3-yl (1,2-DMim)), 4-aza-1-azoniabicyclo[2.2.2]octan-1-yl (or 1,4-diazabicyclo[2.2.2]octane (DABCO) cation), 4-alkyl-1,4-diazoniabicyclo[2.2.2]octan-1-yl (e.g., 4-methyl-1,4-diazoniabicyclo[2.2.2]octan-1-yl (MAABCO) cation), 4-benzyl-1,4-diazoniabicyclo[2.2.2]octan-1-yl (or 1-benzyl-1,4-diazoniabicyclo[2.2.2] octane (BABCO) cation), aliphatic ammonium (e.g., hexyldimethylammonium-1-yl (DMHA), dicyclohexylmethylammonium-1-yl (MCH), methyldi-n-propylammonium-1-yl (MnPr), trimethylammonium-1-yl (TMA), or triethylammonium-1-yl (TEA)), aromatic ammonium (e.g., dialkylbenzylammonium, such as benzyldimethylammonium-1-yl, benzyldiethylammonium-1-yl, benzylhexylmethylammonium-1-yl, benzyldi-n-propylammonium-1-yl, benzylmethyl-n-propylammonium-1-yl, benzyldicyclohexylammonium-1-yl, benzylcyclohexylmethylammonium-1-yl, (3-nitrobenzyl)dimethylammonium-1-yl, or (3-methoxybenzyl)dimethylammonium-1-yl; or dialkyl(phenylalkyl)ammonium, such as dimethyl(phenylhexyl)ammonium-1-yl), and piperidinium (e.g., aliphatic piperidinium, such as 1-methyl-piperidinium-1-yl (Mepip), 1,2-dialkyl-piperidinium, or 1,2-dimethyl-piperidinium-4-yl (DMP); or aromatic piperidinium, such as or 1-benzyl-1-methyl-piperidinium-4-yl (BMP), as well as any piperidinium cation described herein).

Yet other moieties can include -L^{A}-X^{A}, in which L^{A} is a covalent bond (including a spirocyclic bond), optionally substituted aliphatic, optionally substituted alkylene, optionally substituted heteroaliphatic, optionally substituted heteroalkylene, optionally substituted aromatic, optionally substituted arylene, optionally substituted heterocycle, or optionally substituted heterocyclyl (e.g., optionally substituted C₁₋₆ alkylene, optionally substituted C₁₋₆ heteroalkylene, optionally substituted phenylene, or optionally substituted aryleneoxy); and X^{A} is or includes an ionic moiety including one or more nitrogen atoms. Non-limiting ionic moieties include pyridinium (e.g., pyridinum-1-yl, Pyrd; alkylpyridinium, such as 2-methylpyridinum-1-yl, 2MPyrd; or aromatic pyridinium, such as 1-benzylpyridinium-4-yl), imidazolium (e.g., 1,2-dialkylimidazolium-3-yl, including 1,2-dimethylimidazolium-3-yl (1,2-DMim)), 4-aza-1-azoniabicyclo[2.2.2]octan-1-yl (or 1,4-diazabicyclo[2.2.2]octane (DABCO) cation), 4-alkyl-1,4-diazoniabicyclo[2.2.2]octan-1-yl (e.g., 4-methyl-1,4-diazoniabicyclo[2.2.2]octan-1-yl (MAABCO) cation), 4-benzyl-1,4-diazoniabicyclo[2.2.2]octan-1-yl (or 1-benzyl-1,4-diazoniabicyclo[2.2.2] octane (BABCO) cation), aliphatic ammonium (e.g., hexyldimethylammonium-1-yl (DMHA), dicyclohexylmethylammonium-1-yl (MCH), methyldi-n-propylammonium-1-yl (MnPr), trimethylammonium-1-yl (TMA), or triethylammonium-1-yl (TEA)), aromatic ammonium (e.g., dialkylbenzylammonium, such as benzyldimethylammonium-1-yl, benzyldiethylammonium-1-yl, benzylhexylmethylammonium-1-yl, benzyldi-n-propylammonium-1-yl, benzylmethyl-n-propylammonium-1-yl, benzyldicyclohexylammonium-1-yl, benzylcyclohexylmethylammonium-1-yl, (3-nitrobenzyl)dimethylammonium-1-yl, or (3-methoxybenzyl)dimethylammonium-1-yl; or dialkyl(phenylalkyl)ammonium, such as dimethyl(phenylhexyl)ammonium-1-yl), and piperidinium (e.g., aliphatic piperidinium, such as 1-methyl-piperidinium-1-yl, 1,2-dialkyl-piperidinium, or 1,2-dimethyl-piperidinium-4-yl (DMP); or aromatic piperidinium, such as or 1-benzyl-1-methyl-piperidinium-4-yl (BMP), as well as any piperidinium cation described herein).

Such moieties can be associated with one or more counterions. The counterions may be anionic, cationic and/or zwitterionic. For instance, a cationic moiety can be associated with one or more anionic counterions, and an anionic moiety can be associated with one or more cationic counterions. Examples of suitable counterions include, but are not limited to, Cl⁻, Br⁻, I⁻, SO₄²⁻, CO₃²⁻, —COO⁻, HCO₃⁻, PO₃⁻, HPO₄²⁻, Na⁺, K⁺, NH₄⁺, H⁺, Ca²⁺, Mg²⁺, or Al³⁺.

### Linking

Linking of the ionomer with the polystyrene can be promoted by use of linking reagents. For instance, a composition can include polymeric units, and a linking reagent (or linking moiety) can be used to provide the connection between polymeric units. For instance, if the polymeric units (P1 and P2) include a leaving group, then a diamine linking reagent (e.g., H₂N-Ak-NH₂) can be used to react with the polymeric units by displacing the leaving group and forming an amino-containing linker within the composition (e.g., thereby forming P1-NH-Ak-NH—P2). Linkers can be introduced by forming a polymer composition and then exposing the composition to a crosslinking reagent to form crosslinker.

Depending on the functional group present in the material, the reagent can include a nucleophilic group (e.g., an amine or a hydroxyl) or an electrophilic group (e.g., a carbonyl). Thus, non-limiting linking reagents can include amine-containing reagents, hydroxyl-containing reagents, carboxylic acid-containing reagents, acyl halide-containing reagents, or others. Further linking reagents can include:

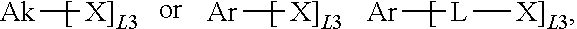

in which Ak is an optionally substituted aliphatic or alkylene; Ar is an optionally substituted aromatic or arylene; L is a linking moiety (e.g., any herein, such as a covalent bond, optionally substituted alkylene, aliphatic, etc.); L3 is an integer that is 2 or more (e.g., 2, 3, 4, 5, 6, or more); and X is halo, hydroxyl, optionally substituted amino (e.g., NR^{N1}R^{N2} in which each of R^{N1} and R^{N2} is, independently, H or optionally substituted alkyl), hydroxyl, carboxyl, acyl halide (e.g., —C(O)—R, in which R is halo), carboxyaldehyde (e.g., —C(O)H), or optionally substituted alkyl. Non-limiting linking reagents can include terephthalaldehyde, glutaraldehyde, ortho-xylene, para-xylene, meta-xylene, or a multivalent amine, such as diamine, triamine, tetraamine, pentaamine, etc., including 1,6-diaminohexane (hexanediamine), 1,4-diaminobutane, 1,8-diaminooctane, propane-1,2,3-triamine, [1,1′:3′,1″-terphenyl]-4,4″,5′-triamine, and others.

After reacting the linking reagent, the composition can include one or more linkers within the composition. If the linking reagent is bivalent, then a linker can be present between two of any combination of polymeric structures, polymeric units, and ionizable/ionic moieties (e.g., between two polymeric units, between two ionizable/ionic moieties, etc.). If the linking reagent is trivalent or of higher n valency, then the linker can be present between any n number of polymeric units, linking moieties, ionizable moieties, and/or ionic moieties. Non-limiting linkers present in the composition include those formed after reacting a crosslinking reagent.

Thus, examples of linkers can include:

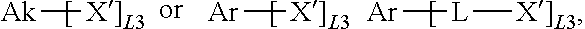

in which Ak is an optionally substituted aliphatic or an optionally substituted alkylene, Ar is an optionally substituted aromatic or an optionally substituted arylene, L is a linking moiety (e.g., any herein, such as a covalent bond, optionally substituted alkylene, optionally substituted aliphatic, etc.), L3 is an integer that is 2 or more (e.g., 2, 3, 4, 5, 6, or more), and X′ is a reacted form of X. In some embodiments, X′ is absent, —O—, —NR^{N1}—, —C(O)—, or -Ak-, in which R^{N1} is H or optionally substituted alkyl, and Ak is optionally substituted alkylene, optionally substituted heteroalkylene, optionally substituted aliphatic, or optionally substituted heteroaliphatic.

The linking may be effected with a linking moiety. Particular chemical functionalities herein can include a linking moiety, either between the parent structure and another moiety (e.g., an ionic moiety) or between two (or more) other moieties. Linking moieties (e.g., L, L′, L¹, L², L³, L⁴, L^{a}, L^{b}, L^{c}, L^{d} L^{A} L^{A′}, L^{A″}, L^{B′}, L^{B″}, L^{2A}, L^{4A}, L^{6A}, L^{8A}, L^{10A}, L^{12A}, and others) can be any useful multivalent group, such as multivalent forms of optionally substituted aliphatic, optionally substituted heteroaliphatic, optionally substituted aromatic, or optionally substituted heteroaromatic.

Non-limiting linking moieties (e.g., L) include a covalent bond, a spirocyclic bond, —O—, —NR^{N1}—, —C(O)—, —C(O)O—, —C(O)—, —SO₂—, optionally substituted alkylene, optionally substituted alkyleneoxy, optionally substituted haloalkylene, optionally substituted heteroalkylene, optionally substituted arylene, optionally substituted aryleneoxy, optionally substituted heterocyclyldiyl, —SO₂—NR^{N1}-Ak-, —(O-Ak)_{L}-SO₂—NR^{N1}-Ak-, -Ak-, -Ak-(O-Ak)_{L1}-, —(O-Ak)_{L1}-, -(Ak-O)_{L1}—, —C(O)O-Ak-, —Ar—, or —Ar—O—, as well as combinations thereof. In particular embodiments, Ak is an optionally substituted aliphatic, optionally substituted alkylene, or optionally substituted haloalkylene; R^{N1} is H or optionally substituted alkyl or optionally substituted aryl; Ar is an optionally substituted aromatic or optionally substituted arylene; and L1 is an integer from 1 to 3.

In some embodiments, the linking moiety is —(CH₂)_{L1}—, —O(CH₂)_{L1}—, —(CF₂)_{L1}—, —O(CF₂)_{L1}—, or —S(CF₂)_{L1}— in which L1 is an integer from 1 to 3. In other embodiments, the linking moiety is -Ak-O—Ar-Ak-O-Ak- or -Ak-O—Ar—, in which Ak is optionally substituted alkylene or optionally substituted haloalkylene, and Ar is an optionally substituted arylene. Non-limiting substituted for Ar includes —SO₂-Ph, in which Ph can be unsubstituted or substituted with one or more halo.

In other embodiments, the linking moiety is a bifunctional compound which has two reactive ends linked by a spacer. As used herein, “spacer” refers to an atom or a group which separates the two reactive (functionalized) ends. The spacer may be an optionally substituted alkyl, aryl or heterocyclyl group in some embodiments. The two reactive ends may each be the same functional group, or each end of the linking moiety may have a different functional group. The bifunctional linking moieties include, but are not limited to, optionally substituted diesters or dicarbamates; or optionally substituted alkyl diammonium compounds or optionally substituted alkyl diimidazolium compounds.

### The Linked Polymers

The linked polymers described herein can include any useful combination of repeating monomeric units. In one instance, the linked polymer can include -A-A-A- or -[A]-, in which A represent a monomeric unit and [A] represents a block including solely A monomeric units. A can be selected from those provided as a polymeric unit and/or a core moiety.

In another instance, the linked polymer includes -[A]-[A-combination-B]—[B]—, in which A and B represents different monomeric units. [A] and [B] represent polymer blocks comprised solely of A monomeric units and solely B monomeric units, respectively. The [A-combination-B]block implies a block including some combination of A and B monomeric units. Each of A and B can be selected from those provided herein as a polymeric unit and/or a core moiety.

In another instance, the linked polymer includes at least one alternating/periodic block, in which the different monomers have an ordered sequence, e.g., -[A-B-A-B— . . . ]-, -[A-B—C-A-B—C— . . . ]-, -[A-A-B—B-A-A-B—B— . . . ]-, -[A-A-B-A-A-B— . . . ]-, -[A-B-A-B—B-A-A-A-A-B—B—B— . . . ]-, etc. A, B, and C represent different monomeric units. The square bracketed examples represent polymer blocks, wherein the monomer sequence is repeated throughout the block. Each of A, B, and C can be selected from those provided as a polymeric unit and/or a core moiety.

In yet another instance, the linked polymer includes a particular unit that is covalently bonded between at least one pair of blocks, e.g., [A]-D-[B] or [A]-D-[B]—[C], in which D can be a monomeric unit or a linking moiety (e.g., any described herein). More than one D can be present, such as in [A]-D-D-[B] or [A]-D-D-D-[B], in which each C can be the same or different. [A] represents a block comprising solely A monomeric units; [B] represents a block comprising solely B monomeric units; [C] represents a block comprising solely C monomeric units; and D can represent individual monomer units (e.g., any described herein) or linking moieties (any described herein). Each of A, B, and C can be selected from those provided as a polymeric unit and/or a core moiety. D can be selected from those provided as a polymeric unit, a core moiety, or a linking moiety (e.g., L).

Other alternative configurations are also encompassed by the linked polymers disclosed herein, such as branched configurations, diblock copolymers, triblock copolymers, random or statistical copolymers, stereoblock copolymers, gradient copolymers, graft copolymers, and combinations of any blocks or regions described herein.

The linked polymers described herein can be characterized by a first molecular weight (MW) of the first polymer, a second MW of the second polymer, or a total MW of the crosslinked polymer. In one embodiment, the first MW, second MW, or total M is a weight-average molecular weight (Mw) of at least 10,000 g/mol, at least 20,000 g/mol, or at least 50,000 g/mol; or from about 5,000 to 2,500,000 g/mol, such as from 10,000 to 2,500,000 g/mol, from 50,000 to 2,500,000 g/mol, from 10,000 to 250,000 g/mol, from 20,000 to 250,000 g/mol, or from 20,000 to 200,000 g/mol. In another embodiment, the first MW, second MW, or total MW is a number average molecular weight (Mn) of at least 20,000 g/mol or at least 40,000 g/mol; or from about 2,000 to 2,500,000 g/mol, such as from 5,000 to 750,000 g/mol or from 10,000 to 400,000 g/mol.

The polymers can include any useful number n, m, m1, m2, m3, or m4 of monomeric units. Non-limiting examples for each of n, m, m1, m2, m3, and m4 is, independently, 1 or more, 20 or more, 50 or more, 100 or more; as well as from 1 to 1,000,000, such as from 10 to 1,000,000, from 100 to 1,000,000, from 200 to 1,000,000, from 500 to 1,000,000, or from 1,000 to 1,000,000. For example, with regard to the structure of formulas (II)—(VIII), n can be 1 when the polymer is made up of a combination of structures, but when the polymer is a homopolymer, n will be at least 4.

### Methods of Making the Copolymers

The present disclosure also encompasses methods of making the disclosed compositions and copolymers, such as those including amine-containing ionizable moieties or an amine-containing ionic moieties, in accordance with certain embodiments.

Any useful synthetic scheme can be employed to provide such ionizable or ionic moieties, such as by way of techniques to append such ionizable/ionic moieties, or by way of catalytic polymerization with monomers including such ionizable/ionic moieties, and the like.

A further step can include exchanging a counterion present in the disclosed compositions and copolymers with another counterion (e.g., exchanging a halide counterion for a hydroxide counterion). Yet other steps can include exposing the disclosed compositions and copolymers to crosslinking reagents to form one or more crosslinker between a combination of polymeric units, core moieties, ionizable moieties, or ionic moieties.

Non-limiting reaction schemes are illustrated in Schemes 1 and 2 below, which are useful for preparation of an exemplary copolymer of the general Formula XII. In the Schemes, the controlled radical polymerization may be a reversible addition-fragmentation polymerization (RAFT) or an atom transfer radical polymerization, effected with base or hydrogen peroxide treatment. The two polymers are linked in the Schemes through a linking moiety which has two reactive functional groups. The link between the polymers may be formed from diisocyanato compounds such as the depicted hexamethylenediisocyanate (Scheme 1) or the depicted toluene 2,6-diisocyanate (Scheme 2). Suitable alkyldiisocyanate linking groups may have a one to twenty carbon chain length and may be substituted or unsubstituted. The ratio of p:m:o:x may be tuned to desired proportions by adjustment of reaction conditions. Once formed, hydroxyl termination of the copolymers may be accomplished by a base/water quench procedure. In these Schemes, trifluoromethane sulfonic acid is abbreviated as TFSA and trimethylamine is abbreviated as TMA.

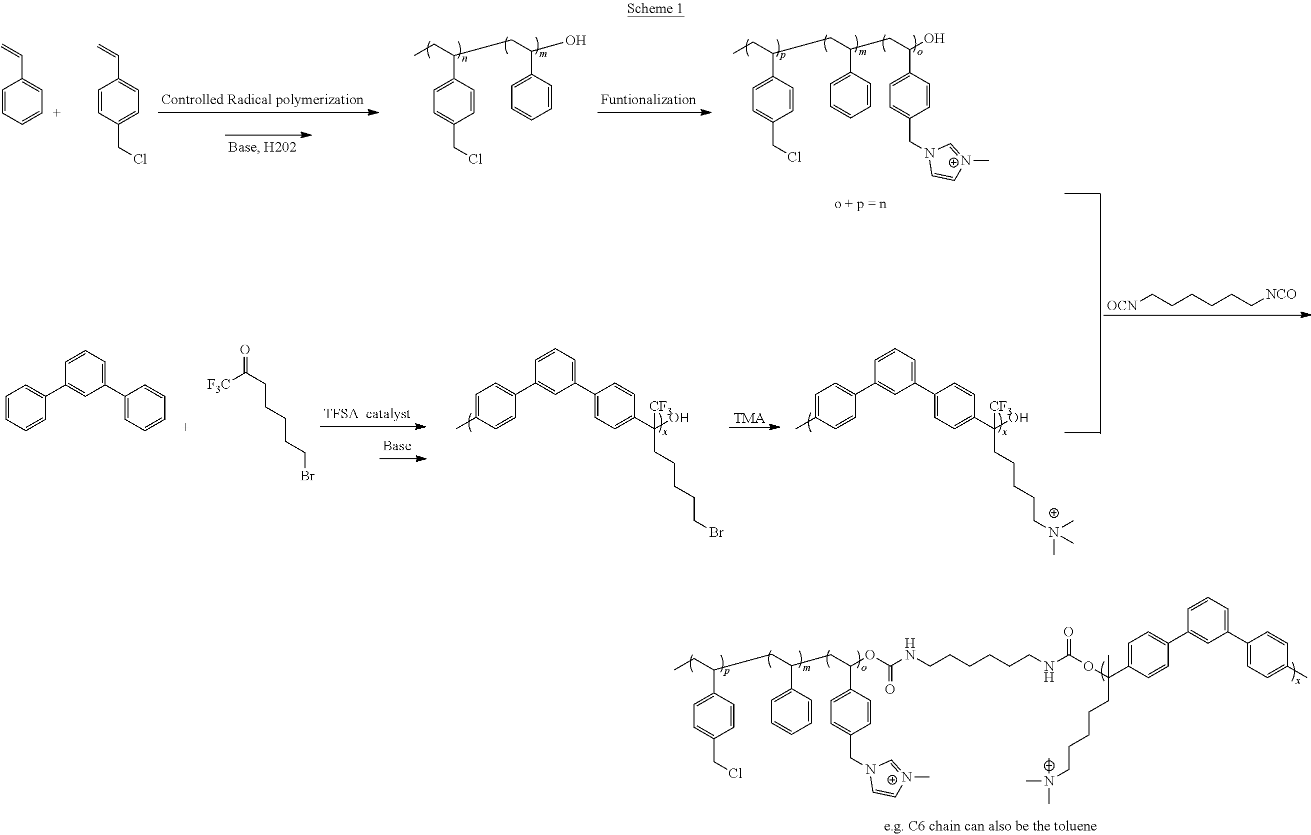

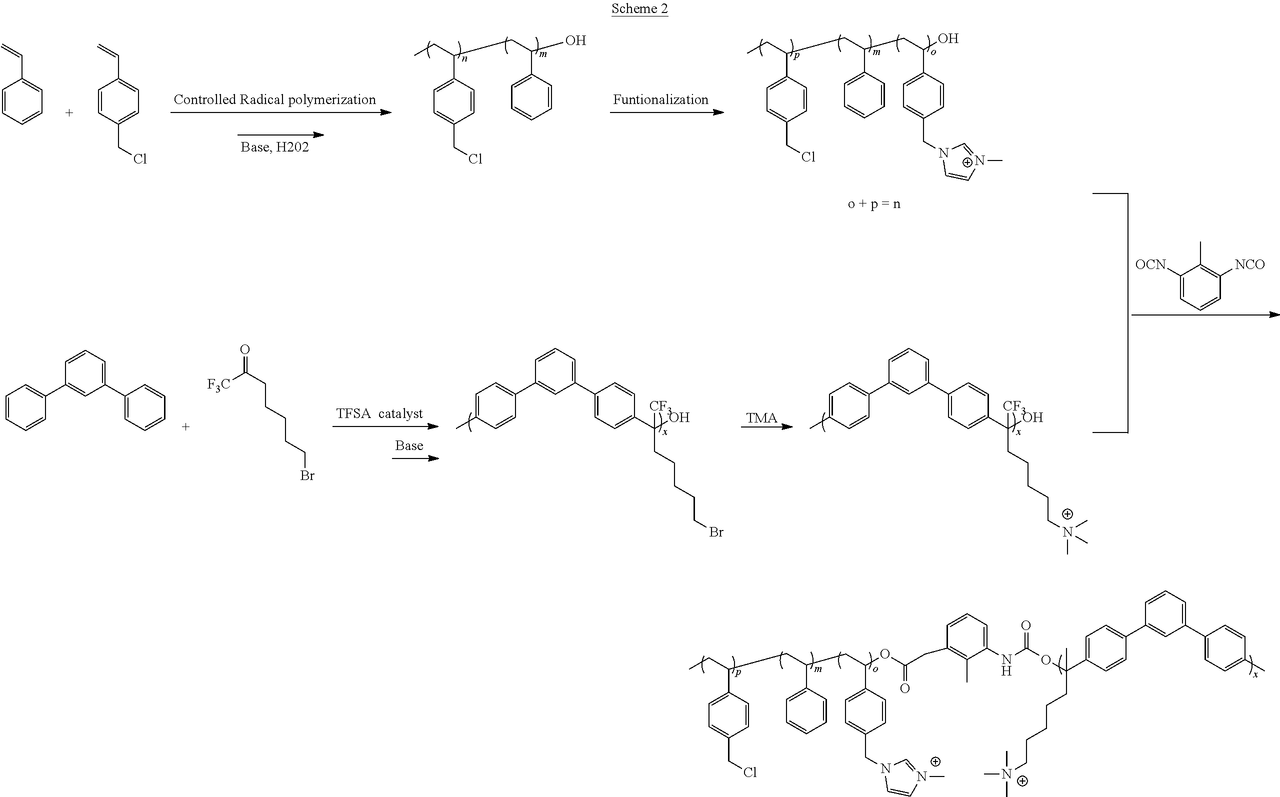

However, other useful synthetic schemes may also be employed to provide the copolymers of general Formula XII.

Another non-limiting reaction scheme is illustrated in Scheme 3 below, which is useful for preparation of an exemplary copolymer of the general Formula XIII. The copolymer is formed by directly linking one polymer to the other through a substituent of a pendant aryl group in Scheme 3. The o:p:m ratio may be controlled during polymerization and/or functionalization with the imidazole group. Trifluoromethane sulfonic acid is abbreviated as TFSA and trimethylamine is abbreviated as TMA.

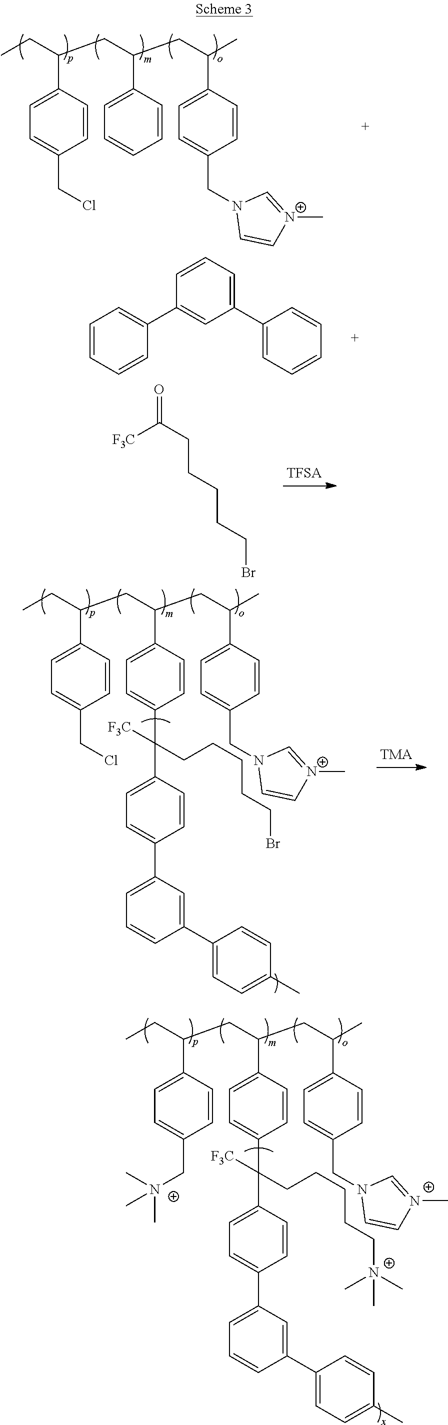

However, other useful synthetic schemes may also be employed to provide the copolymers of general Formula XIII.

A further non-limiting reaction scheme is illustrated in Scheme 4 below, which is useful for preparation of an exemplary copolymer of the general Formula XIV. This reaction scheme illustrates a linkage of the two polymers through side chains of each polymer backbone. The linkage may be formed from a linking moiety which has two reactive functional groups. Suitable alkyl difunctionalized linking groups may have a one to twenty carbon chain length, and may be substituted or unsubstituted. In Scheme 4, the linkage is formed from an alkyl diimidazole.

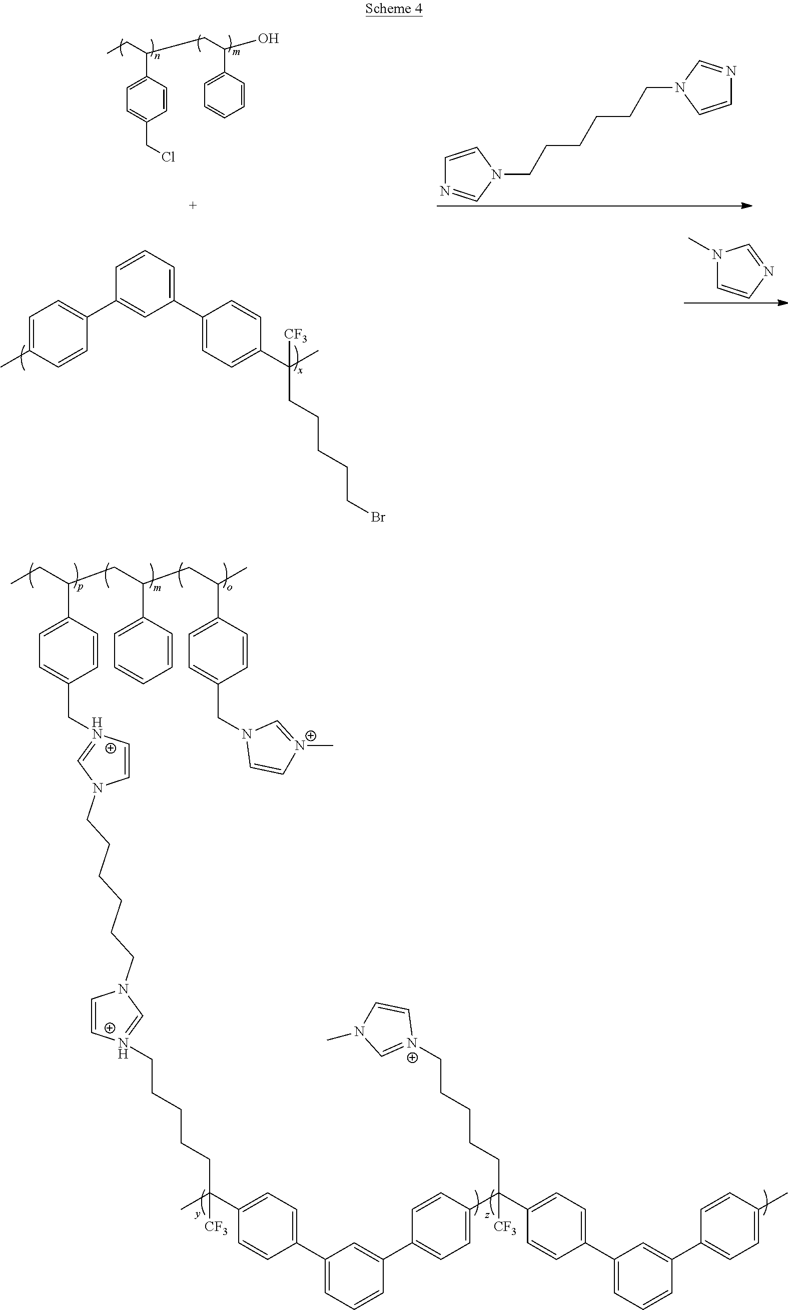

However, other useful synthetic schemes may also be employed to provide the copolymers of general Formula XIV.

### Uses

The compositions herein can be employed to form a material, such as a film, a membrane (e.g., an ion exchange membrane), or a crosslinked polymeric matrix. The composition and material thereof can be employed within a device or apparatus, such as an electrochemical cell. In one embodiment, the electrochemical cell includes an anode, a cathode, and a polymer electrolyte membrane (PEM) disposed between the anode and the cathode. The PEM (or a component thereof) can include any composition or material described herein.

The compositions herein can be employed as a component for a membrane electrode assembly (MEA). A non-limiting MEA can include a cathode layer having a reduction catalyst and a first ion-conducting polymer; an anode layer having an oxidation catalyst and a second ion-conducting polymer; a membrane layer having a third ion-conducting polymer between the anode layer and the cathode layer; and a cathode buffer layer having a fourth ion-conducting polymer between the cathode layer and the membrane layer. The membrane layer (e.g., PEM) can provide ionic communication between the cathode layer and the anode layer or can conductively connect the cathode layer and the anode layer. The cathode buffer layer can conductively connect the cathode layer and the membrane layer. Any of the polymers in the MEA (e.g., as a first, second, third, and/or fourth ion-conducting polymer) can include a composition as described herein.

In some embodiments, the cathode buffer layer has a first porosity between about 0.01 and 95 percent by volume (e.g., wherein the first porosity is formed by the inert filler particles, such as diamond particles, boron-doped diamond particles, polyvinylidene difluoride (PVDF) particles, and polytetrafluoroethylene (PTFE) particles).

The compositions herein can be employed in a reactor. Non-limiting reactors include an electrolyzer, a carbon dioxide reduction electrolyzer, an electrochemical reactor, a water electrolyzer, a gas-phase polymer-electrolyte membrane electrolyzer, but can additionally or alternatively include any other suitable reactors. The reactor may include one or more: electrodes (e.g., anode, cathode), catalysts (e.g., within and/or adjacent the cathode and/or anode), gas diffusion layers (e.g., adjacent the cathode and/or anode), and/or flow fields (e.g., defined within and/or adjacent the electrodes and/or gas diffusion layers, such as one or more channels defined opposing the cathode across the gas diffusion layer). In some embodiments, the reactor includes a membrane stack or membrane electrode assembly (MEA) having one or more polymer electrolyte membranes (PEMs), providing ionic communication between the anode and cathode of the reactor. In certain embodiments, the reactor includes a membrane stack including: a cathode layer including a reduction catalyst and an ion-conducting polymer; a PEM membrane (e.g., bipolar membrane, monopolar membrane, etc.; membrane including one or more anion conductors such as anion exchange membranes (AEMs), proton and/or cation conductors such as proton exchange membranes, and/or any other suitable ion-conducting polymers; membrane including one or more buffer layers; etc.); and an anode layer including an oxidation catalyst and an ion-conducting polymer. The ion-conducting polymers of each layer can be the same or different ion-conducting polymers. In particular embodiments, the membrane, membrane stack, membrane electrode assembly (MEA), polymer electrolyte membrane (PEM), and/or ion-conducting polymer includes a composition described herein.

In one embodiment, the water electrolyzer includes a membrane electrode assembly (MEA). The MEA used for water electrolysis can include a cathode and an anode separated by an ion-conducting polymer layer that provides a path for ions to travel between the cathode and the anode. The cathode and the anode each contain ion-conducting polymer and catalyst particles. One or both may also include electronically conductive catalyst support. The ion-conducting polymer in the cathode, anode, and ion-conducting polymer layer may be either all cation-conductors or all anion-conductors.

In one embodiment, the carbon dioxide reduction electrolyzer includes a membrane electrode assembly (MEA). The MEA can include one or more ion-conducting polymer layers (e.g., including any composition described herein) and a cathode catalyst for facilitating chemical reduction of carbon dioxide to carbon monoxide.

In some configurations, a bipolar MEA has the following stacked arrangement: cathode layer/cathode buffer layer (an anion-conducting layer)/cation-conducting layer (with may be a PEM)/anode layer. In some implementations, the bipolar MEA has a cathode layer containing an anion-conducting polymer and/or an anode layer containing a cation-conducting layer. In some implementations, the bipolar MEA has an anode buffer layer, which may contain a cation-conducting material, between the cation-conducting layer and the anode layer. The cathode layer, cathode buffer layer, anion-conducting layer, cation-conducting layer, and/or anode layer can include any composition described herein.

In some configurations, a bipolar MEA has the following stacked arrangement: cathode layer/cation-conducting layer (with may be a PEM)/anion-conducting layer/anode layer. In some applications, a bipolar MEA having this arrangement is configured in a system for reducing a carbonate and/or bicarbonate feedstock such as an aqueous solution of carbonate and/or bicarbonate. The cathode layer, cation-conducting layer, anion-conducting layer, and/or anode layer can include any composition described herein.

In some configurations, an MEA has the following stacked arrangement: cathode layer/anion-conducting layer/bipolar interface/cation-conducting layer/anode layer. The bipolar interface can include, e.g., a cation-and-anion conducting polymer, a third polymer different from the polymers of the anion-conducting polymer layer and the cation-conducting polymer layer, a mixture of an anion-conducting polymer and a cation-conducting polymer, or a cross-linking of the cation-conducting polymer and anion-conducting polymer. The cathode layer, anion-conducting layer, bipolar interface, cation-conducting layer, and/or anode layer can include any composition described herein.

In some configurations, an MEA has the following stacked arrangement: cathode layer/anion-conducting layer/anode layer. In some implementations, this MEA has no cation-conducting layers between the cathode layer and the anode layer. In some applications, an MEA containing only anion-conducting material between the cathode and anode is configured in a system for reducing carbon monoxide feedstock. The cathode layer, anion-conducting layer, and/or anode layer can include any composition described herein.

The compositions herein can be provided in a layer (e.g., a membrane layer or others herein) having any suitable porosity (including, e.g., no porosity or a porosity between 0.01-95%, 0.1-95%, 0.01-75%, 1-95%, 1-90%, etc.). In some embodiments, the composition can provide a layer (e.g., a membrane) that is chemically and mechanically stable at a temperature of 80° C. or higher, such as 90° C. or higher, or 100° C. or higher. In other embodiments, the composition is soluble in a solvent used during fabrication of a layer (e.g., an organic solvent, such as methanol, ethanol, isopropanol, tetrahydrofuran, chloroform, toluene, or mixtures thereof). In particular embodiments, the composition, a layer thereof, or a membrane thereof is characterized by an ion exchange capacity (IEC) from about 0.2 to 3 milliequivalents/g (meq./g), such as from 0.5 to 3 meq./g, 1 to 3 meq./g, or 1.1 to 3 meq./g. In some embodiments, the composition, a layer thereof, or a membrane thereof is characterized by a water uptake (wt. %) from about 2 to 180 wt. %, such as from 10 to 180 wt. %, 20 to 180 wt. %, 50 to 180 wt. %, 10 to 90 wt. %, 20 to 90 wt. %, or 50 to 90 wt. %. In other embodiments, the composition, a layer thereof, or a membrane thereof is characterized by an ionic conductivity of more than about 10 mS/cm. In any embodiment herein, a layer, a membrane, or a film including a composition herein has a thickness from about 10 to 300 μm, such as from 20 to 300 μm, 20 to 200 μm, or 20 to 100 μm. In any embodiment herein, the composition, a layer thereof, or a membrane thereof is characterized by minimal or no light absorbance at wavelength from about 350 nm to 900 nm, about 400 nm to 800 nm, or about 400 nm to 900 nm.

A layer or a membrane can be formed in any useful manner. In one embodiments, a composition (e.g., an initial polymer or an ionic polymer) can be dissolved in a solvent (e.g., any described herein, such as an organic solvent, including methanol, ethanol, isopropanol, tetrahydrofuran, chloroform, toluene, o-dichlorobenzene, m-dichlorobenzene, p-dichlorobenzene, naphthalene, α-naphthol, or combinations thereof) to from a casting solution. The casting solution can be optionally filtered, applied to a substrate, and then dried to form a film. Application to a substrate can include doctor blade coating, solution casting, spraying, dip coating, spin coating, extrusion, melt casting, or a combination of any technique. The film can be optionally further treated, such as by immersion in any reagents herein (e.g., ionizable reagent, crosslinking reagent, counterion, solvent including water, etc., and combinations thereof).

Further uses, membranes, assemblies, and configurations are described in U.S. application Ser. No. 15/586,182, filed May 3, 2017, published as U.S. Pat. Pub. No. 2017/0321334, by Kuhl et al., entitled “Reactor with advanced architecture for the electrochemical reaction of CO₂, CO and other chemical compounds”; U.S. Appl. No. 63/060,583, filed Aug. 3, 2020, and International Appl. No. PCT/US2021/044378, filed Aug. 3, 2020, by Flanders et al., entitled “System and method for carbon dioxide reactor control”; and U.S. Appl. No. 62/939,960, filed Nov. 25, 2019, and International Publication No. WO 2021/108446, by Huo et al., entitled “Membrane electrode assembly for COx reduction,” each of which are incorporated herein by reference in its entirety.

### CONCLUSION

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

What is claimed is:

1. A polymer comprising a structure of formula (I):
P1-L-P2 (I),
or a salt thereof, wherein
P1 is an ionomer having an aromatic hydrocarbon-containing backbone and an amine-containing ionizable moiety or an amine-containing ionic moiety; and
P2 is a polystyrene having a hydrocarbon backbone and pendant optionally substituted phenyl rings; and
L is a linking moiety or a covalent bond.

2. The polymer of claim 1, wherein the ionomer comprises structures of formula: 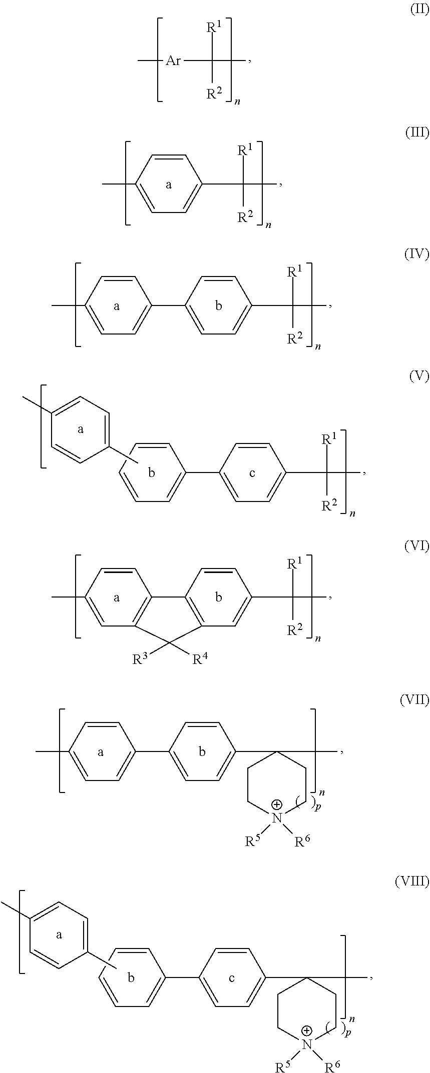
or a salt thereof,
wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety;
R³ and R⁴ each independently comprise H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R³ and R⁴ can be taken together to form an optionally substituted cyclic group;
R⁵ and R⁶ each independently comprise H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R⁵ and R⁶ can be taken together to form an optionally substituted cyclic group;
Ar includes or is an optionally substituted aromatic or optionally substituted arylene;
n is an integer of 1 or more;
p is 0, 1, 2, or more; and
each of ring a, ring b, and ring c may independently be optionally substituted with one or more substituents comprising alkyl, alkoxy, amino, aminoalkyl, aryl, arylalkenyl, aryoyl, aryloxy, arylalkoxy, cyano, hydroxy, hydroxyalkyl, nitro, halo or haloalkyl; and
wherein at least one of rings a-c, R¹, R², R³, and R⁴ of formulas (II)-(VI) is or includes an amine-containing ionizable moiety or an amine-containing ionic moiety.

3. The polymer of claim 2, wherein at least one of R¹ and R² is a side chain comprising the amine-containing ionizable moiety or the amine-containing ionic moiety.

4. The polymer of claim 3, wherein the amine-containing ionic moiety comprises optionally substituted pyrazolium, optionally substituted pyridinium, optionally substituted pyrazinium, optionally substituted pyrimidinium, optionally substituted pyridazinium, optionally substituted piperidinium, optionally substituted pyrrolidinium, optionally substituted indolizinium, optionally substituted isoindolium, optionally substituted indazolium, optionally substituted imidazolium, optionally substituted oxazolium, optionally substituted triazolium, optionally substituted tetrazolium, optionally substituted thiazolium, optionally substituted purinium, optionally substituted isoquinolinium, optionally substituted quinolinium, optionally substituted phthalazinium, optionally substituted quinooxalinium, optionally substituted phenazinium, optionally substituted morpholinium, immonium, ammonium, guanidinium or histidinium.

5. The polymer of claim 2, wherein the polystyrene comprises a structure of formula (IX): 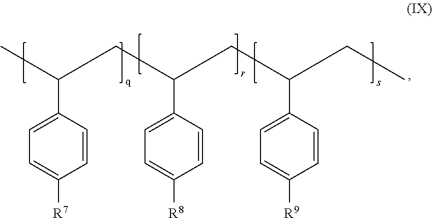
wherein R⁷, R⁸ and R⁹ each independently comprise H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷, R⁸ and R⁹ is or includes an ionizable moiety or an ionic moiety;
and each occurrence of q, r and s is independently an integer of 1 or more.

6. The polymer of claim 2, wherein the ionomer comprises a structure of formula (V): 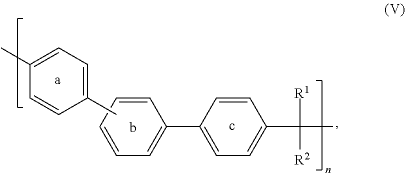
and R¹ comprises haloalkyl.

7. The polymer of claim 6, wherein R¹ comprises trifluoromethyl and R² comprises a structure of formula (X):
—(C(R¹⁰)₂)ₜR¹¹ (X),
wherein each R¹⁰ independently comprises H, aliphatic, aralkyl, aryl, heteroaryl, alkoxy, aryloxy, thioalkyl, thioaralkyl, thioaryl, aminoalkyl, amino, aminoaryl, halo or hydroxyl;
R¹¹ comprises amino or nitrogen-containing heterocyclyl; and
t is an integer of 1 to 30.

8. The polymer of claim 6, wherein R¹ comprises trifluoromethyl and R² comprises a structure of formula (XI): 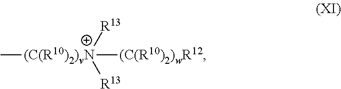
wherein each R¹⁰ independently comprises H, alkyl, aralkyl, aryl, heteroaryl, alkoxy, aryloxy, thioalkyl, thioaralkyl, thioaryl, aminoalkyl, amino, aminoaryl, halo or hydroxyl;
R¹² comprises amino, aryl, heterocyclyl, hydroxyl, dihydroxyl, sulfhydryl, sulfide, disulfide, sulfo, or thioester;
each R¹³ independently comprises H or aliphatic;
v is an integer of 1 to 30; and
w is an integer of 1 to 10.

9. The polymer of claim 1, wherein L is a linking moiety and wherein the linking moiety is a bifunctional moiety having two reactive ends linked by a spacer.

10. The polymer of claim 9, wherein the spacer comprises optionally substituted alkyl, optionally substituted aryl or optionally substituted heterocyclyl.

11. The polymer of claim 9, wherein each of the two reactive ends comprises the same functional group.

12. The polymer of claim 11, wherein the same functional group comprises an ether, an ester, a carbamate ester, an amide, an amine, a ketone, an epoxide, a heterocycle or a thioether.

13. The polymer of claim 3, wherein the linking moiety connects the side chain of the ionomer comprising the amine-containing ionizable moiety or the amine-containing ionic moiety to a pendant optionally substituted phenyl ring of the polystyrene.

14. The polymer of claim 1, wherein the linking moiety connects the aromatic hydrocarbon-containing backbone of the ionomer to the hydrocarbon backbone of the polystyrene.

15. The polymer of claim 14, wherein the linking moiety comprises an optionally substituted alkyl, optionally substituted diester or optionally substituted aryl dicarbamate ester.

16. The polymer of claim 1, wherein L is a covalent bond and wherein the covalent bond connects the aromatic hydrocarbon-containing backbone of the ionomer to a pendant optionally substituted phenyl ring of the polystyrene.

17. The polymer of claim 16, wherein the linking moiety comprises an optionally substituted alkyl diammonium or optionally substituted alkyl diimidazolium.

18. The polymer of claim 5, wherein the polystyrene is a terpolymer, and the terpolymer comprises a pendant alkyl imidazolium-substituted phenyl ring.

19. A branched polymer comprising a structure of formula (XII): 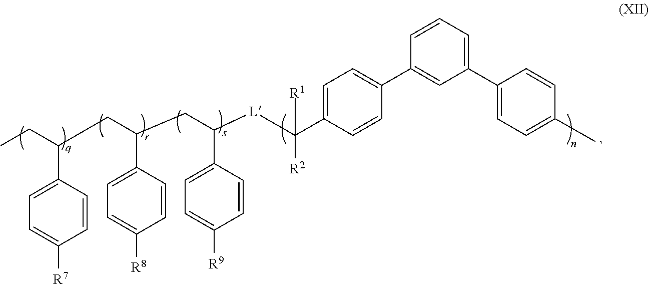
or a salt thereof,
wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety;
R⁷, R⁸ and R⁹ each independently comprise H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷, R⁸ and R⁹ is or includes an ionizable moiety or an ionic moiety;
L′ is a linking moiety and wherein the linking moiety is a bifunctional moiety having two reactive ends linked by a spacer;
n is an integer of 1 or more; and
each occurrence of q, r and s is independently an integer of 1 or more.

20. The branched polymer of claim 19, wherein the spacer comprises optionally substituted alkyl, optionally substituted aryl or optionally substituted heterocyclyl.

21. The branched polymer of claim 19, wherein each of the two reactive ends comprises the same functional group.

22. The branched polymer of claim 21, wherein the same functional group comprises an ether, an ester, a carbamate ester, an amide, an amine, a ketone, an epoxide, a heterocycle or a thioether.

23. A branched polymer comprising a structure of formula (XIII): 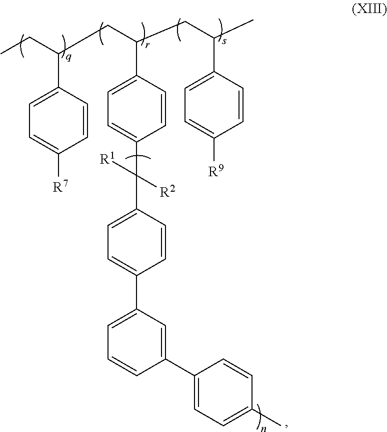
or a salt thereof,
wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety;
R⁷ and R⁹ each independently comprise H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁷ and R⁹ is or includes an ionizable moiety or an ionic moiety;
n is an integer of 1 or more; and
each occurrence of q, r and s is independently an integer of 1 or more.

24. A crosslinked polymer comprising a structure of formula (XIV): 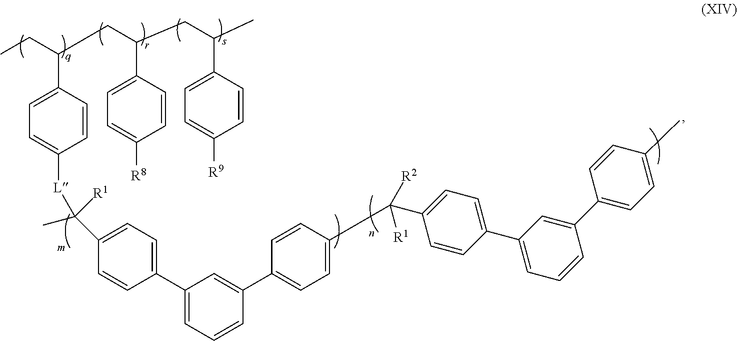
or a salt thereof,
wherein R¹ and R² each independently comprise an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or wherein R¹ and R² can be taken together to form an optionally substituted cyclic group and wherein at least one of R¹ or R² comprises an electron-withdrawing moiety;
R⁸ and R⁹ each independently comprise H, halo, optionally substituted aliphatic, optionally substituted alkyl, optionally substituted heteroaliphatic, optionally substituted heteroalkyl, optionally substituted aromatic, optionally substituted heterocyclyl, optionally substituted aryl, or optionally substituted arylalkylene, and at least one of R⁸ and R⁹ is or includes an ionizable moiety or an ionic moiety;
L″ is a linking moiety and wherein the linking moiety is a bifunctional moiety having two reactive ends linked by a spacer;
each occurrence of m and n is independently an integer of 1 or more;
and each occurrence of q, r and s is independently an integer of 1 or more.

25. The crosslinked polymer of claim 24, wherein the spacer comprises optionally substituted alkyl, optionally substituted aryl or optionally substituted heterocyclyl.

26. The crosslinked polymer of claim 24, wherein each of the two reactive ends comprises the same functional group.

27. The crosslinked polymer of claim 24, wherein the same functional group comprises an ether, an ester, a carbamate ester, an amide, an amine, a ketone, an epoxide, a heterocycle or a thioether.

28. An electrochemical cell comprising:
an anode;
a cathode; and
a polymer electrolyte membrane disposed between the anode and the cathode, wherein the polymer electrolyte membrane comprises the polymer of claim 1.
